(19) United States
(12) Patent Application Publication
(10) Pub. No.: US 2014/0360660 A1
(43) Pub. Date: Dec. 11, 2014

(54) METHOD AND APPARATUS FOR CONTINUOUS PRODUCTION OF BALLOONS, AIRSHIPS, INFLATABLE STRUCTURAL MEMBERS AND OTHER INFLATABLE STRUCTURES

(71) Applicant: Raven Industries, Inc. and Grieg Stovall Latham, Sioux Falls, SD (US)

(72) Inventors: Greig Stovall Latham, Lucas, TX (US); Michael Scott Smith, Sulphur Springs, TX (US)

(21) Appl. No.: 14/301,016

(22) Filed: Jun. 10, 2014

Related U.S. Application Data
(60) Provisional application No. 61/833,058, filed on Jun. 10, 2013.

(51) Int. Cl. B29C 65/74

(52) U.S. Cl. CPC B29C 65/7459
USPC 156/269; 156/516; 156/498

(57) ABSTRACT

An automated manufacturing method of balloons and sheet based articles includes layering a second sheet over a first sheet, the layered first and second sheets form a first layer section. The first layer section is moved relative to a cutting and joining assembly. The first layer section is cut and joined into article sections with the cutting and joining assembly. Cutting and joining includes scribing the cutting and joining assembly along a scribing line across the moving first layer section, and joining the first article portions of the first and second sheets along the scribing line with the cutting and joining assembly to form a first plurality of article sections. Cutting and joining further includes cutting the first layer section according to scribing and moving along the scribing line, each of the first and second sheets cut into the first article portions facing each other.

### CLAIM OF PRIORITY

This patent application claims the benefit of priority U.S. Provisional Patent Application Ser. No. 61/833,058, filed on Jun. 10, 2013, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc.; Sioux Falls, S. Dak. All Rights Reserved.

### TECHNICAL FIELD

This document pertains generally, but not by way of limitation, to the assembly and manufacturing of balloons and sheet based objects.

### BACKGROUND

Balloons, airships, aerostats, inflatable structures, and sheet based objects (e.g., constructed with films, flexible panels, textiles or the like) are assembled in some examples from a plurality of flexible panels. In one example, balloons are formed from a plurality of gores. For instance, a high-altitude, research balloon is often constructed with 30 or more diamond shaped gores.

Two or more gores are cut from rolls of material having a consistent width. The scrap from cutting is collected and discarded. The cut gores are individually arranged on an assembly table (sometimes measuring 2,000 square feet or more). Adhesive tape, stitching or heating is applied along the edges of the gores to join the gores together. Aligning the gores, in some examples measuring 60 feet or longer, is time consuming and subject to misalignment because of manipulation of the gores during joining along the edges. Manipulation of the gore is conducted continuously as the edges are arranged for joining and the joining process continues along the edges. Such manipulation prompts continued realignment of the gores. In some examples, several skilled assembly technicians assemble approximately two balloons or sheet based objects in this manner per week.

### Overview

The present inventors have recognized, among other things, that a problem to be solved can include decreasing the assembly time for balloon and sheet based objects. For instance, multi-section assembly methods for an article, such as a balloon, are conducted in some examples on assembly tables by hand with sheets of material measuring hundreds or thousands of square feet. Technicians work with the sections on the assembly tables to form seams along each of the respective edges. The process is laborious and time consuming.

In an example, the present subject matter can provide a solution to this problem, such as by providing an automated method of cutting and joining flexible panels of material in a sequential fashion to form an article including balloons or sheet—based articles. The method assembles two or more sheets into layer sections and translates the layer sections (e.g., from spools of sheet materials, extruders or the like) relative to a cutting and joining assembly. The cutting and joining assembly is moved over the translating layer section and joins the two or more sheets along a scribing line (e.g., a computer controlled joining and cutting line specific to the desired article section of an article). The cutting and joining assembly cuts the layer section along the scribing line. The cutting and joining is optionally carried out in a continuous lineal manner without the need to pause, rearrange, stack or otherwise manipulate the sheets.

In another example, the automated method stacks the article sections, for instance through the operation of a second assembly station having a second set of spools with third and fourth sheets of material. These sheets in turn form a second layer section that is joined and cut with a second cutting and joining assembly to form a second article section. The second article section is stacked with the first article section with at least two edges of the article sections (e.g., free edges of the sheets) aligned. An edge joining assembly thereafter joins the first and second article sections along the aligned edges. The method (cutting and joining of supplemental layer sections and stacking with the preceding article sections) is repeated for any number of article sections.

In yet another example, the ultimate (e.g., last) free edges of the article are joined with a closing seal (e.g., to complete the perimeter of a balloon, inflatable structure, article or the like).

Optionally, the automated method staggers identical article sections that are cut (and joined) according to identical article patterns that follow prescribed corresponding scribing lines. Accordingly, with a single cutting and joining step (e.g., along the scribing line) the method generates dual articles (article sections) with each cutting and joining operation. In another example, the article patterns and corresponding scribing lines generate differing article sections on either side of the scribing line. In one example, the differing article sections are used for differing parts of the same article, differing articles, or one of the article sections is discarded.

The present inventors have recognized, among other things, that a problem to be solved can include consolidating multiple cutting and joining steps and mechanisms into a single system or line. For instance, in previous assembly examples multiple gores were cut from a roll of material according to a pattern provided on an assembly table. After cutting, each of the gores are arranged and aligned on an assembly table and then joined along edges. Because precise alignment of the gores is needed for joining the edges are joined in a sequential fashion (e.g., a pair of edges is joined, and then the next pair of edges is joined after).

In an example, the present subject matter can provide a solution to this problem, such as by providing an automated method and assembly that consolidates cutting and joining of a plurality of panels together to fashion a complete or nearly complete balloon or sheet based article. The cutting and joining assembly described herein includes a cutting and joining head having a joining section configured to join at least two sheets of a layered sheet and a cutting section configured to cut the layered sheet. In one example, the cutting and joining head is coupled with a moving assembly arm with an articulating joint. As a layered sheet is translated relative to the cutting and joining head the assembly arm (e.g., through a reciprocating carriage or other actuator) moves the cutting and joining head relative to the layered sheet. The cutting and joining head simultaneously (e.g., near simultaneous or simultaneous) joins the layered sheets along a scribing line and cuts along the scribing line.

In another example, the joining section of the assembly joins the sheets along at least two seams along the scribing line and the cutting section cuts the layered sheet between the two seams to form separate article sections (e.g., for separate articles such as two balloons). As described above, the cutting and joining assembly, in an example, can cut and join layered sheets (e.g., layer sections) to form staggered article sections for at least two articles at the same time. In another example, the cutting and joining assembly is continuously operated (e.g., along a repeating scribing line) to correspondingly generate a continuous output of article sections for articles including, but not limited to, balloons, inflatable structures, sheet based articles or the like.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic view of a flow chart for an automated method of article manufacturing.

FIG. 2 is a schematic view of one example of an article manufacturing system for a multi-section article.

FIG. 3 is a perspective view of one example of an article manufacturing station for use in the article manufacturing system of FIG. 2.

FIG. 4 is a schematic view of a cutting and joining assembly moving over a translating layer section of at least two sheets of material.

FIG. 5A is a schematic view of one example of the layer section of FIG. 4 cut and joined to form article sections of two separate articles.

FIG. 5B is a cross sectional view of the layer section of FIG. 5A showing a plurality of article sections in an aligned stacked configuration with the sheets joined and cut.

FIG. 6A is a cross sectional view of a stack of article sections including joined edges of the article sections.

FIG. 6B is a side view of one example of an edge joining assembly for joining the edges of two stacked article sections.

FIG. 7 is a cross sectional view of a stack of article sections including joined edges for an assembly of two article section sets and joined edges applied between two article section sets.

FIG. 8A is a schematic view of one example of tendon liners coupling tendons along the joined edges of article sections.

FIG. 8B is a perspective view one example of a tendon liner.

FIG. 9A is a schematic view of one example of a closing edge of an article.

FIG. 9B is a schematic view of another example of a closing edge of an article.

FIG. 10 is a perspective view of the article manufacturing station of FIG. 3 with a layered sheet extending between upper and lower portions of a cutting and joining assembly.

FIG. 11 is a side view of the article manufacturing station of FIG. 10 showing one example of a reciprocating carriage coupled with the assembly arm.

FIG. 12 is a detailed perspective view of one example of a cutting and joining assembly.

FIG. 13A is a detailed perspective view of an outboard side of cutting and joining head shown in FIG. 12.

FIG. 13B is a perspective view of a revealed portion of an inboard side of the cutting and joining head shown in FIG. 12.

FIG. 14 is a partial section of the arm of the cutting and joining assembly shown in FIG. 12.

FIG. 15A is a rear view of one example of an elevation mechanism for the cutting and joining head assembly.

FIG. 15B is a side schematic view of the elevation mechanism of FIG. 15A.

FIG. 16A is a first example of an article including a balloon constructed according to the embodiments described herein.

FIG. 16B is a second example of an article including an inflatable structure constructed according to the embodiments described herein.

FIG. 16C is a third example of an article including a multi-chamber bioreactor.

### DETAILED DESCRIPTION

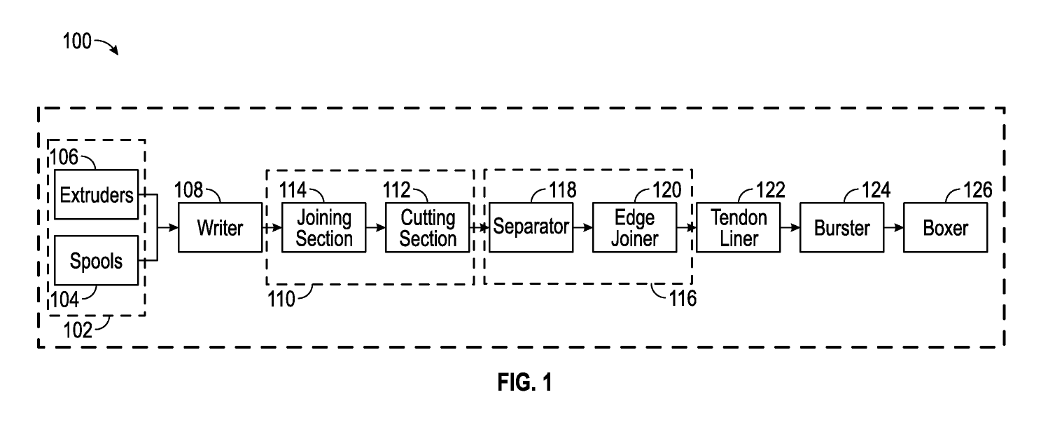

FIG. 1 shows one example of an article assembly line 100. As shown the article assembly line 100 includes a plurality of components configured to automatically manufacture and assemble a balloon or other sheet based article. As described herein, the article assembly line 100 and its constituent components are configured to generate one or more article sections and couple the article sections in an automated fashion to thereby form one or more articles including but not limited to balloons, film or sheet based articles or the like.

The article assembly line 100 includes a plurality of article manufacturing stations (described herein) using one or more sheet housings 102, for instance spools 104 of material such as a flexible sheet or film. In another example, the one or more sheet housings 102 include, but are not limited to, extruders 106 configured to generate material as a film or sheets for assembly in the article assembly line 100. The flexible sheet or film is translated along the article assembly line 100 for a series of manufacturing assembly steps including, but not limited to, layering the film or sheet based material with other corresponding layers or sheets (e.g., as layered sheets) and then selectively cutting and joining the layers to form the article sections of the resulting article.

In one example, where the sheet housings 102 include extruders 106, the extruders include polymer film or sheet manufacturing systems including an extruder head or the like configured to take a liquid or semi-liquid polymer solution and form one or more of sheets or films of the polymer for use in the article assembly line 100. In the example where the sheet housings 102 include one or more spools 104, the spools retain rolls of one or more sheets of films, such as continuous sheets of material, for layering and eventual cutting and joining as described herein. Optionally, the spools 104 are double rolled with two or more sheets of film, fabric or the like. In another example, the spools 104 are rolled with a continuous tubular sheet of film, fabric or the like. When wrapped around the spool 104 the tubular sheet forms dual layers corresponding to first and second sheets, as described herein. Accordingly the spools 104 in one example includes a single spool 104 having double rolled or tubular film, fabric or the like. In yet another example, the sheet housings 102 include one or more magazines configured to hold a plurality of stacked sheets that are individually drawn from the magazines for use in the cutting and joining assembly 110.

Referring again to FIG. 1, the article assembly line 100 optionally includes a writer 108. In one example, the writer 108 is configured to apply one or more of decorations, painting, manufacturing markings or the like to the sheets provided by the sheet housings 102. In another example, the writer 108 is excluded from the article assembly line and instead the sheets from the sheet housings 102 are passed along the assembly line to the cutting and joining assembly 110. The writer 108, in one example provides assembly identification, such as bar coding, article section reference numbers, identification chips or the like. Assembly notations are used to identify portions of the layered sheets, for instance, corresponding to one or more article sections (described herein) for one or more articles. In one example, the assembly notations are used by downstream components of the article assembly line 100 to identify article sections for varying assembly or processing steps, or to facilitate separation and gathering of varied article sections (e.g., differing materials, shapes, sizes or the like) for differing articles. In still another example, assembly notations are used by technicians at a downstream location to provide one or more instructions for manual (e.g., by hand or machine) interaction with the articles including, but not limited to, the coupling of ports such as inflation and deflation ports, the coupling of instrument packages or the like.

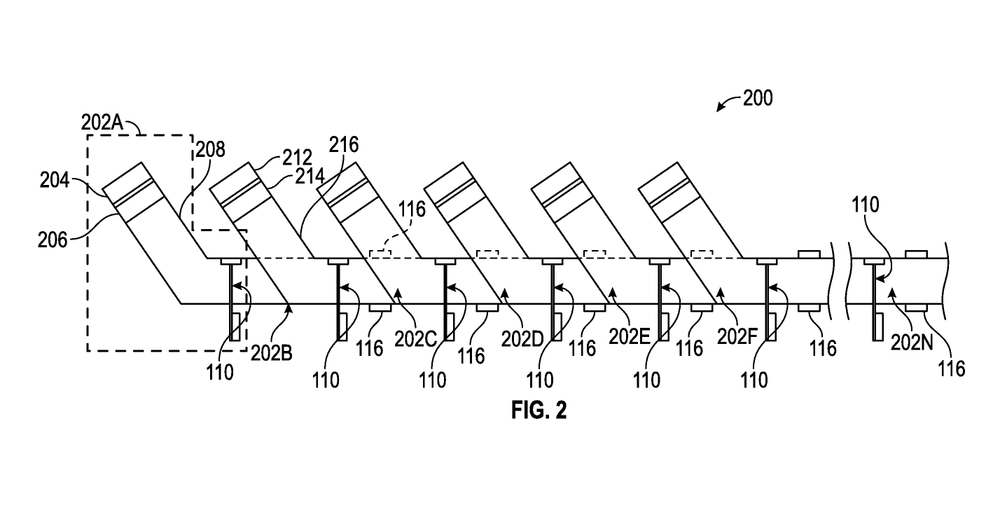

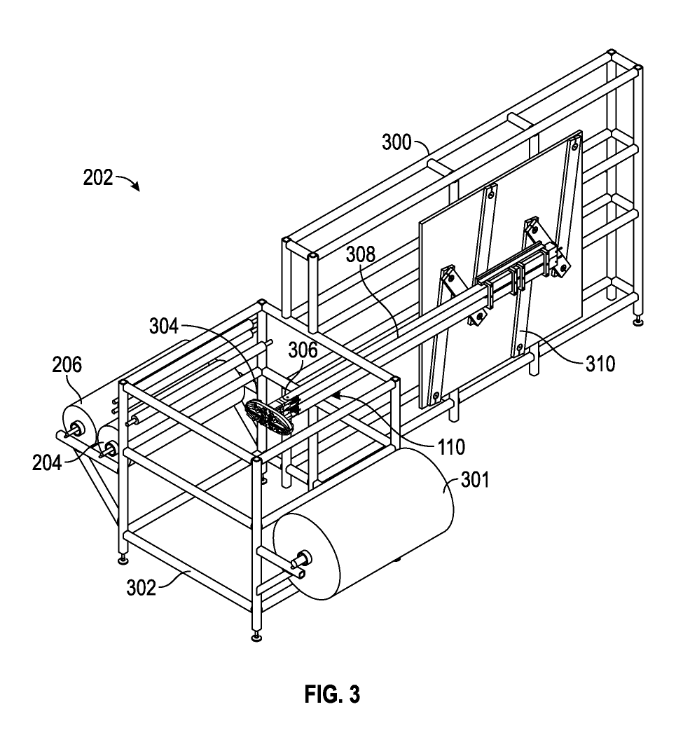

An exemplary cutting and joining assembly 110 is shown in FIG. 1. In one example, the cutting and joining assembly 110 includes a consolidated set of features or mechanisms including a cutting section 112 and a joining section 114. In one example and as described herein the cutting section 112 and the joining section 114 are consolidated in each of a plurality of article manufacturing stations 202A-N (e.g., see FIGS. 2 and 3). For instance, each of the article manufacturing stations 202A-N includes a cutting and joining head. The cutting and joining sections 112, 114 cooperatively join the opposed layers of layered sheets (e.g., sheets, panels or films) distributed from the sheet housings 102, for instance layers of sheet material distributed by the spools 104 or extruders 106. The cutting section 112 slits the layered sheets, for instance along the joined seams created by the joining section 114. That is to say, in one example the joining section 114 is configured to join opposing sheets of material generated from the sheet housings 102. The cutting section 112 extends along a same line, for instance a scribing line used by the joining section 114, to accordingly cut or slit the sheet materials along (e.g., between) the seams (and the scribing line) provided by the joining section 114. In one example the joining section 114 provides opposed seams along a scribing line. In such an example the cutting section 112 is configured to divide the layered sheet of sheet material along the scribing line, for instance between the opposed seams formed by the joining section 114.

As further shown in FIG. 1 the article assembly line 100 further includes an edge joining assembly 116. In one example the edge joining assembly 116 includes a separator 118 and an edge joiner 120. As will be described herein the separator 118 separates two or more portions of the layered sheets (e.g., an upper and lower sheet of each of two layered sheets) joined at the cutting and joining assembly 110. The separator 118 merges the separated sheets from the layered sheets along aligned edges of the sheets to allow for joining along those edges at an edge joiner 120. Stated another way, in one example and as described herein, a plurality of article manufacturing stations 202A-N are provided on the example article assembly line 100. Each of the article manufacturing stations 202A-N generate one or more article sections. As the article sections are formed at each of the respective article manufacturing stations they are stacked on top of each other and passed through the edge joining assembly 116. The edge joining assembly 116 is configured to separate one or more of the sheets of each of the article sections and join them at the edge joiner 120. Accordingly, the article sections generated by the respective article manufacturing stations are joined along one or more edges (e.g., aligned edges) to accordingly form a portion of an overall article.

As will be further described this process is duplicated with a plurality of article manufacturing stations 202B-N to accordingly generate larger articles including additional article sections that are subsequently joined as desired by downstream edge joining assemblies 116. For instance an article manufacturing station 202A-N is provided for each of the article sections of a particular article. Similarly an edge joining assembly 116 is provided for a corresponding number of article manufacturing stations. For instance, at least one edge joining assembly 116 is provided for each joined edge of the article generated by the article assembly line 100 (e.g., N−1 edge joining assemblies 116 for a corresponding number of article manufacturing stations 202A-N).

In another example, an additional feature, such as a tendon liner 122 is provided in the article assembly line 100. The optional tendon liner 122 is in one example incorporated with the edge joining assembly 116. Where the article assembly line 100 is configured to generate an inflatable balloon the tendon liner 122 is optionally included to provide one or more tendons along the article sections. The tendons are retained along the article sections. As described herein, in one example the tendons are retained along seams provided at aligned edges of the article sections with the edge joiner 120. The tendons provide additional structural integrity to the resulting balloon article.

In another example the article assembly line 100 includes a burster 124. As will be described herein, in one example a plurality of article sections are assembled with the cutting and joining assembly 110 (e.g., article manufacturing stations 202A-N) and the corresponding edge joining assemblies 116. The article sections are in one example formed in opposed and staggered configurations. That is to say the varying shapes of each of the article sections are formed along a scribing line provided by the article manufacturing stations. In one example, upper and lower pluralities of article sections (e.g., one or more article sections formed continuously or discontinuously from a layered sheet as described herein) are provided along the scribing line. The cutting section 112 optionally provides a perforated cut to the layered sheets forming each of the article sections. The burster 124 pulls each of the article sections away from its mate (e.g., the upper from the lower plurality of article sections relative to the orientation on the page, equivalent to outer and inner respective positions relative cutting and joining assemblies 110) and accordingly finishes separating the article sections by fracturing along the perforated cut line to facilitate packaging of individual completed articles. In still another example, pluralities of article sections retain a perforated connection and are rolled together, for instance onto a spool for packaging.

As shown in FIG. 1, the article assembly line 100 further includes a boxer 126. As will be described herein, in one example the articles generated by way of the article assembly line 100 are provided in a linear stacked fashion, for instance with each of one or more article sections stacked one on top of each other in a pre-folded and aligned configuration according to the seams provided by one or more of the cutting and joining assembly 110 and the edge joining assembly 116. This stacked configuration of the article is easily delivered into the boxer 126 to accordingly position the finished article (already folded) within an open box. In one example the boxer 126 allows for the lineal delivery of the article into a box and accordingly leaves at least one of the ends of the receiving box open for instance to allow for further manipulation of the article. In one example further manipulation of the article includes but is not limited to providing one or more of inflation ports, deflation ports, instrumentation packages or the like to the resulting article.

FIG. 2 shows one example of an article manufacturing system 200. In the example shown in FIG. 2 the article manufacturing system 200 corresponds to one or more of the components of the article assembly line 100 shown in FIG. 1. For instance, as shown the article manufacturing system 200 includes the sheet housings 102, the cutting and joining assemblies 110, and edge joining assemblies 116. As shown in FIG. 2, a plurality of article manufacturing stations 202A-N corresponding to a plurality of cutting and joining assemblies 110 are provided in sequence along the article manufacturing system. For instance, as shown in FIG. 2 at least six exemplary article manufacturing stations 202A-N are provided.

As further shown in FIG. 2, edge joining assemblies 116 are provided along the article manufacturing system 200. As previously described, the edge joining assemblies 116 are configured to join article sections generated from pairs of the article manufacturing stations 202A-N. Accordingly in the example shown in FIG. 2 the article manufacturing station 202A and the adjacent article manufacturing station 202B each generate at least one article section. The article section of the second article manufacturing station 202B is layered over top of the first article section from the station 202A. The edge joining assembly 116 joins at least one aligned edge of each of the article sections together to accordingly form a larger portion of the resulting article. As will be described herein this process is repeated at each of the article manufacturing stations 202A-N (generation of the article sections) and the edge joining assemblies 116 in line to accordingly generate the resulting article including one or more joining seams. In another example, the edge joining assemblies 116 are incorporated with one or more of the article manufacturing stations 202A-N, for instance article manufacturing stations 202B-N.

Referring again to FIG. 2, each of the article manufacturing stations 202A-N as shown includes at least one sheet housing 102. In the example shown, the stations 202A-N include first and second sheet housings 102. For the article manufacturing station 202A, the sheet housings include the first sheet housing 204 having a first sheet (e.g., sheet, film, fabric, pliable material or the like) therein and the second sheet housing 206 including a second sheet therein. In one example the first and second sheets are formed of an identical material and provided on opposing spools upstream from the cutting and joining assemblies 110. In another example, the first and second sheets include differing materials. In still another example, the first and second sheets are provided in a discontinuous linear format that is sequentially fed into the article manufacturing system 200. In yet another example and as previously described and shown in FIG. 1 the sheet housings 102 include extruders 106 having extruder components configured to generate two or more films that are layered together.

Optionally, the sheet housings 204, 206 include a single sheet housing provided for each of the article manufacturing stations 202A-N. In one example, the single sheet housing 102 includes a tubular sheet of a film, fabric, pliable material or the like wound around a spool. When wound on a spool, the tubular sheet provides two virtual sheets corresponding to the upper and lower half of the tube. In another example, two or more sheets are double wound on a spool. The sheet housings 204, 206 optionally includes a single sheet housing with either of the tubular sheet of film, fabric or the like or a spool with a double winding of a film, fabric, pliable material or the like.

In still another example, the sheet housings 204, 206 include one or more magazines configured to hold a plurality of stacked sheets (e.g., discontinuous or continuously layered in a serpentine manner) that are individually drawn from the magazines for use in the cutting and joining assembly 110.

As shown in FIG. 2, the first and second sheets provided by the first and second sheet housings 204, 206 are layered together prior to reception at the cutting and joining assembly 110. In one example, the layered sheets are identified (for convention) as a first layer section 208, a first layered sheet 208 or the like. As will be described herein a cutting and joining head of the cutting and joining assembly 110 moves over the first layer section 208 as the first layer section moves from left to the right along the article manufacturing system 200. The cutting and joining assembly 110 moves over the translating first layer section 208 along a predefined scribing line. For instance, in one example the scribing line is generated virtually according to a desired article section pattern and corresponding movement of the cutting and joining assembly 110 relative to the first layer section 208 while the first layer section 208 is translated from the left to the right. As the first layer section 208 including the second sheet layered over the first sheet is fed to the cutting and joining assembly 110 the cutting and joining assembly moves over the first sheet and under the second sheet and accordingly joins the first and second sheets along corresponding first and second seams (e.g., along the scribing line). The cutting and joining assembly 110 cuts (e.g., fully cuts, provides a perforation or the like) the first layer section 208 along the first and second seams, for instance between the first and second seams to form separate article sections. In one example, the separate article sections are identical. In yet another example the article sections are staggered. For instance, as the cutting and joining assembly 110 moves according to a reciprocating action of a motor coupled with the cutting and joining assembly 110 a staggered pattern is formed between the upper and lower sides of the first layer section 208 (e.g., relative to the orientation of the page, outer and inner relative to the assembly 110). Accordingly a staggered series of article sections are generated by the moving, cutting and joining assembly 110. The staggered series of article sections are optionally identical (though staggered) according to the pattern of the scribing line (movement of the cutting and joining assembly 110).

As further shown in FIG. 2 at least another article manufacturing station 202B is provided downstream from the first article manufacturing station 202A. In the example shown the second article manufacturing station 202B includes a third sheet housing 212 and a fourth sheet housing 214. The third and fourth sheet housings 212, 214 accordingly generate a second layer section 216 (or second layered sheet 216) having the fourth sheet layered over top of the third sheet. This resulting second layer section 216 is lapped over top of the first layer section 208 (previously cut and joined). The cutting and joining assembly 110 of the second article manufacturing station 202B accordingly operates on the second layer section 216 and similarly joins and cuts the second layer section 216, for instance in an identical pattern to the scribing line provided and used in the cutting and joining assembly 110 to form the opposed article sections. The first and second article manufacturing stations 202A, B generate identical article sections layered over each other. In another example the article sections generated by the first and second article manufacturing stations 202A, B are different according to varying scribing lines used by the respective cutting and joining assemblies 110.

After layering of the first and second layer sections 208, 216 and cutting and joining of the sections (with the cutting and joining assemblies 110) the resulting article sections are delivered to the edge joining assembly 116. In one example the edge joining assembly 116 is provided on both the upper and lower edges of the first and second layer sections 208, 216 as they move along the article manufacturing system 200 from the left to the right. The edge joining assembly 116 as previously described in FIG. 1 in one example includes a separator 118 and an edge joiner 120. The separator separates at least one of the sheets of each of the resulting article sections of the first and second layer sections 208, 216 (after cutting and joining of the respective layers) and joins these edges (e.g., aligned edges of the sheets) to couple the article sections resulting from each of the article manufacturing stations 202A, B. Accordingly the article sections from the first article manufacturing station 202A and the article sections from the second article manufacturing station 202B are coupled together along at least one aligned edge to accordingly form a larger portion of the overall article.

The system of article manufacturing stations 202A-N followed by an edge joining assembly 116 is continued along the article manufacturing system 200 according to the number of individual article sections specified for a particular article. Stated another way, additional article manufacturing stations 202C-N are provided in the article manufacturing system 200 to accordingly form each of the article sections for a desired article. Further, additional edge joining assemblies 116 are provided to couple each of the article sections with preceding article sections from the other article manufacturing stations 202C-N.

Referring again to FIG. 2 in one example the article manufacturing system 200 is used to generate a plurality of identical article sections and sequentially join each of the article sections to form an article such as a balloon. In one example, the second layer section 216 and succeeding layer sections assembled by each of the article manufacturing stations 202C-N (joined and cut to form respective article sections) are layered over the preceding cut and joined first layer section 208 in an identical pattern. For instance, the footprint of each of the seams and cut lines of the preceding cutting and joining assembly 110 (e.g., the scribing line) is duplicated at the succeeding cutting and joining assemblies 110 for the subsequent layer section. The footprint of the subsequent layer section (e.g., 216) is then aligned with the preceding footprints of the preceding article sections. Accordingly the layered layer sections and corresponding article sections from the subsequent article manufacturing stations 202B-N have identical seams and cuts that identically overlay the seams and cuts of preceding article sections of the first layer section 208. Accordingly, the article sections are automatically laid over each other in a stack having identical and aligned patterns. The edge joining assemblies 116 join aligned edges of these stacked and aligned article sections to form the article, for instance the balloon.

In another example, each of the article manufacturing stations 202A-N including the cutting and joining assemblies 110 cut and join sheets to form article sections having differing patterns. Accordingly, each of the article manufacturing stations 202A-N layers article sections having differing shapes, sizes or the like over top of preceding article sections. A variety of article sections having differing shapes, sizes and the like are assembled on the article manufacturing system 200, stacked and then joined, for instance with the edge joining assemblies 116. In such an example, the article manufacturing system 200 is used to form other sheet based articles differing from articles having a consistent shape, such as balloons.

As will be described the methods and systems describe herein are configurable to generate articles including, but not limited to, balloons, aerostats, airships, inflatable housing structures, mats, bioreactor devices, liners for large containers, inflatable bridge structures, skeletal or structural support elements, inflatable lifting structures, or the like.

FIG. 3 shows one example of an article manufacturing station, for instance, one of the article manufacturing stations 202A-N shown in FIG. 2. As shown the exemplary article manufacturing station 202 includes an arm frame 300 coupled with an assembly frame 302. In one example the assembly frame 302 includes the first and second sheet housings 204, 206. As shown in the example, the first and second sheet housings 204, 206 correspond to two spools provided upstream from the cutting and joining assembly 110. In another example, and as previously described with regard to FIG. 1 the first and second sheet housings 204, 206 correspond to one or more extruders 106.

In one example, downstream from the cutting and joining assembly 110 a drive mechanism is provided, for instance a roller 301. In another example, the roller 301 is configured to engage with a layered sheet, for instance the first layer section 208, second layer section 216 and so on after passage of the first layer section or the like through the cutting and joining assembly 110. Stated another, way the driver roller 301 translates the first layer section 208 through the cutting and joining assembly 110 (e.g., by pulling of the section 208). In yet another example, the roller 301 is a take up roller, and the drive mechanism for the corresponding layer section (or sections) is provided by a roller or other mechanism downstream from the cutting and joining assembly 110.

The article and manufacturing system 200 manipulates the layered sheets (second layers 208, 216 and the like) with one or more transport mechanisms in addition to or alternatively from the rollers 301. Examples of the transport mechanisms include transport (gripping) chains. The transport changes provide an affirmative grasp along the edges of the layered sheets. Optionally, each of the article manufacturing stations 202A-N includes a dedicated transport chain system that moves the layer sections and joined article sections through the station and releases the joined article sections at an interface with another station where it is grasped by the next set of transport chains (e.g., at each of the two edges of the article section). In another example, the transport mechanism includes a conveyor including one or more rollers (e.g., roller 301), belt conveyors or the like. Optionally, the rollers are vacuum rollers with perforations that provide a negative pressure to grasp the layered sheets, including thin films. The vacuum is adjusted with a slide plate that selective widens or narrows the openings of the perforations. Vacuum rollers facilitate grasping and picking up of the layered sheets, changing direction of the sheets in the process flow, and accurate positioning of the sheets to provide the aligned edges for the edge seams as described herein. In another example, a conveyor system is a vacuum conveyor having floor sections, and one or more of the floor sections includes perforations for drawing of negative pressure. In still other examples, the transport mechanisms include, but are not limited to, electrostatic pads, suction cups or the like, used for moving the layered sheets (e.g., first layer section 208, section stacks 501 or the like) or aligning the sheets for joining, cutting, packing operations or the like.

As further shown in FIG. 3, the cutting and joining assembly 110 extends from the arm frame 300 into the assembly frame 302. The cutting and joining assembly 110 includes in the example shown a cutting and joining head 304 coupled with an assembly arm 308 by way of an articulating joint 306. Each of the cutting and joining head 304, the articulating joint 306 as well as the assembly arm 308 are divided into upper and lower portions. Accordingly the sheet based material, such as the first layer section 208, second layer section 216 or the like passing through the assembly frame 302 is delivered between each of the upper and lower portions of these respective components. Accordingly, the cutting and joining assembly 110 translates, for instance in a linear reciprocating fashion as will be described herein, over top of and below the first layer section 208 as it passes through the assembly frame 302. In such an example each of the upper and lower portions of the cutting and joining head 304 separately articulate and move over the section 208 as it passes therebetween. As will be further described herein, each of the upper and lower portions of the cutting and joining head 304 are thereby able to articulate along a scribing line and each is able to provide one or more of cutting and joining to opposed sides of the first layer section 208. This arrangement of the cutting and joining assembly 110 is optionally duplicated for each of the article manufacturing stations 202A-N.

As further shown in FIG. 3, the arm frame 300 is coupled with the assembly frame 302. In one example the arm frame 300 includes a translation mechanism 310, for instance a plurality of multi-bar mechanisms configured to translate the assembly arm 308 in a reciprocating motion. In one example the translation mechanism 310 includes dual three-bar mechanisms and the assembly arm 308 is coupled with intermediate bars of each of the three-bar mechanisms. The assembly arm 308 is held at a stationary elevation while translating the cutting and joining head 304 over top of and below the first layer section 208 delivered through the assembly frame 302. In one example a reciprocating motor assembly, for instance a rotational motor having a two-bar mechanism or the like, is coupled with one or more of the three-bar mechanisms to accordingly provide the reciprocating motion to the translation mechanism 310.

In yet another example, the translation mechanism 310 includes, but is not limited to, a rack and pinion system using linear bearings, reciprocating piston (hydraulic, pneumatic or the like), actuator or the like configured to provide movement to the assembly arm 308 and the cutting and joining head 304.

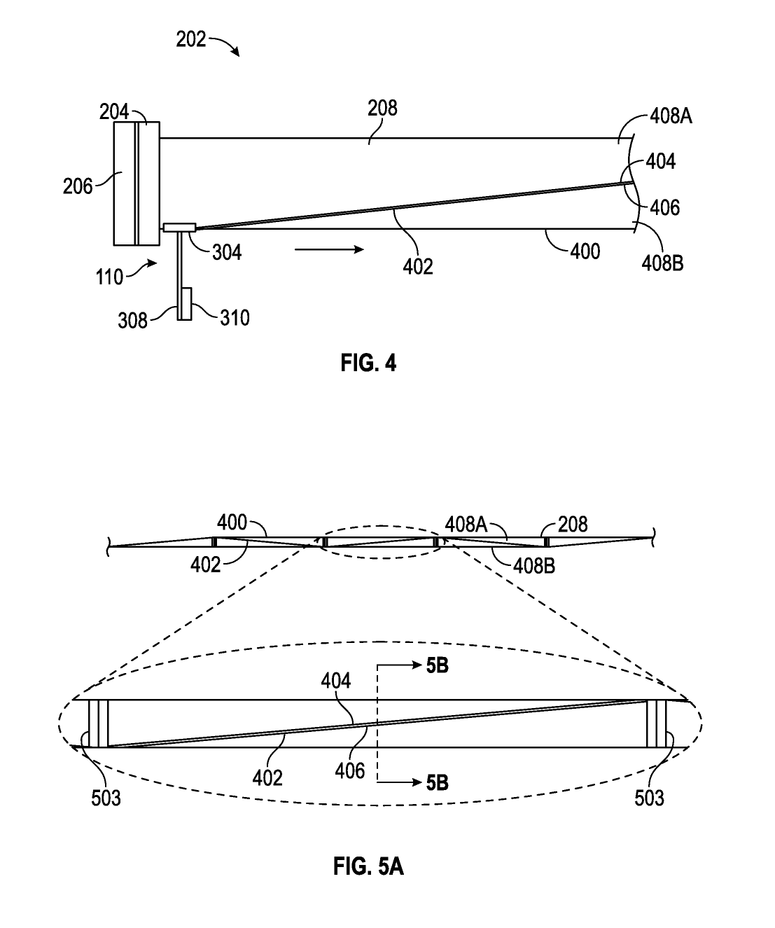

FIG. 4 shows a schematic view of one example of an article manufacturing station 202 (e.g., exemplary of the article manufacturing stations 202A-N shown previously in FIG. 2). In the example shown in FIG. 4 the first layer section 208 (also shown as a first plurality of article sections 400) moves from left to right relative to the cutting and joining assembly 110. As shown the cutting and joining assembly 110 including the cutting and joining head 304 is shown at the bottommost portion of its translation stroke relative to the first layer section 208. The scribing line 402 is shown by each of the first and second seams 404, 406 extending at a diagonal along the first layer section 208. The first and second seams 404, 406 (and the virtual scribing line 402) are formed on the first layer section according to the translation of the cutting and joining assembly 110 (for instance in a vertical fashion relative to the page) while the first layer section 208 is translated from the left to the right (again relative to the orientation of the page) by a driving mechanism, such as the roller 301 shown in FIG. 3. As previously described herein the cutting and joining head 304 also cuts the first layer section 208 (layered sheet) between each of the first and second seams 404, 406. Accordingly the cutting and joining assembly 110 provides the first and second seams 404, 406 and similarly separates (e.g., fully cuts, provides a perforated cut or the like) each of the sheets of the first layer section 208 into an upper plurality of article sections 408A and a lower plurality of article sections 408B (relative to the orientation shown on the page, outer and inner respectively relative to the cutting and joining assembly 110). As shown in FIG. 4 each of the upper and lower plurality of article sections 408A and 408B have a staggered configuration. For instance, each of the article sections 408A, 408B is an identical mirror image of the other provided in a staggered fashion with the lower plurality of article sections 408B leading the upper plurality of article sections 408A in the view provided in FIG. 4.

In one example where the scribing line 402, the corresponding first and second seams 404, 406 and the cut line are formed on the first layer section 208 to provide identical upper and lower pluralities of article sections 408A, 408B (e.g., staggered) two identical article sections are generated by the article manufacturing station 202. The identical article sections accordingly are used for two separate articles, such as two separate balloons and the method of cutting and joining the first layer section (and subsequent layer sections) produces little to no waste. In another example, where the scribing line 402 and the corresponding seams 404, 406 provide differing upper and lower pluralities of article sections 408A, 408B one or more of the upper or lower plurality of article sections are used to generate the article while the other plurality of article sections (e.g., the lower or upper plurality) is discarded or used for a differing portion of the article or a differing article.

In still another example, the first layer section 208 shown in FIG. 4 is provided in a continuous fashion through the article manufacturing station 202 from the first and second sheet housings 204, 206. In another example, the article manufacturing station 202 receives discontinuous lineal sheets that are individually handled and cut by the cutting and joining head 304 of the cutting and joining assembly 110. The discontinuous article sections are delivered to succeeding article manufacturing stations (e.g., stations 202B-N as shown in FIG. 2) and stacked with additional article sections generated at those stations downstream from the article manufacturing station 202 shown in FIG. 4. (See FIG. 2).

In still another example, the cutting and joining head 304 is configured to provide perforated cuts between the first and second seams 404, 406. The perforated cut between the first and second seams 404, 406 maintains the upper and lower plurality of article sections 408A, 408B in a coupling relationship during manipulation of the first layer section 208 for instance along the article manufacturing system 200. Separation of the upper and lower pluralities of article sections 408A, 408B (one or more article sections continuously or discontinuously formed from the first layer section) is temporarily prevented as the first layer section 208 is delivered through the article manufacturing system 200. By maintaining a constant width of the first layer section 208 (and subsequent layer sections), by not separating the upper and lower pluralities of article sections, the handling of the first (and subsequent layer sections) is made easier, for instance, with a constant upper and lower straight edge of the pluralities of upper and lower article sections 408A, B. Accurate layering and alignment of scribing lines (seams and cut lines) of succeeding layer sections, such as the second layer section 216 (FIG. 2), over top of the preceding first layer section 208 is made easier with the perforated cut and maintenance of a connection between the article sections.

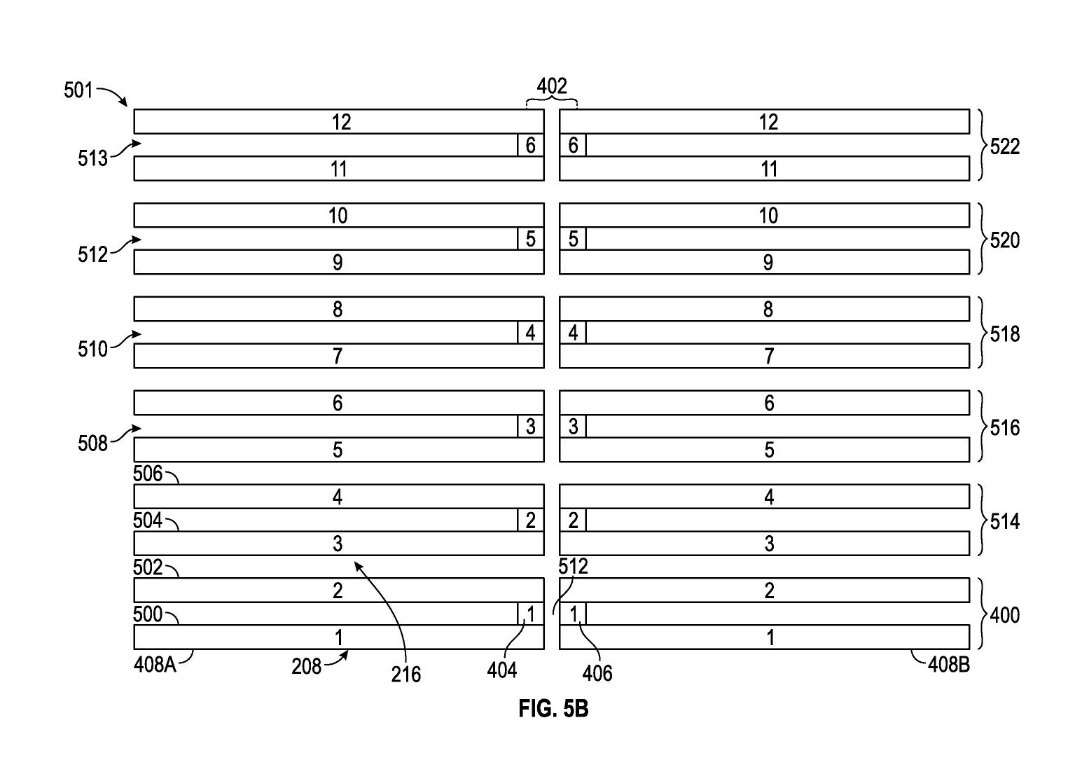

Referring now to FIG. 5A the upper view shows the first layer section 208 formed into the first plurality of article sections 400 provided in a continuous lineal configuration (e.g., from a spool or extruder). As shown, the scribing line 402 is provided along the first layer section 208 in a continuous wave-like pattern. The scribing line 402 follows a series of angles over the first layer section 208 to accordingly provide opposed staggered triangular patterns for each of the upper and lower plurality of article sections 408A, 408B. The triangular pattern of the second sheet of each of the sections is joined with a corresponding triangular pattern of the first sheet positioned beneath the second sheet along the first and second seams 404, 406. The pattern is continuously formed and repeated as the first layer section 208 is delivered through the article manufacturing station 202.

A more detailed view of a portion of the first layer section 208 is also provided in FIG. 5A. For instance, the first and second seams 404, 406 are shown along the scribing line 402. In one example, a cut or perforated cut (described herein) is provided between each of the first and second seams 404, 406. In the example where the first layer section 208 is used to form part of a plurality of balloons the article sections are formed diamond or “gore” shapes shown in FIG. 5A including the first and second stacked sheets of the first layer section 208. A plurality of component equators 500 are provided at the ends of each of the first and second seams 404, 406 corresponding to the troughs and peaks of the scribing line 402. In one example, the plurality of component equators 500 (the widest portion of the respective upper and lower pluralities of article sections 408A, B) of the article sections when combined form the equator of a balloon, the largest diameter portion of a balloon between the balloon upper and lower peaks. As shown in FIGS. 5A, B the component equators 500 form a cylindrical belt for a balloon because of their consistent width extending across the first layer section 218. The narrowest portion of each of the respective upper and lower pluralities of article sections 408A, B correspond to portions of the upper and lower apexes of a balloon.

FIG. 5B shows a cross section of an article section stack 501 taken along section line 5B-5B in FIG. 5A across a midpoint of the scribing line 402 between a peak and a trough. The article section stack 501 includes multiple pluralities of article sections 400, 514, 516, 518, 520, 522 (or more). Each of the pluralities of article sections includes one or more component article sections formed continuously or discontinuously from the corresponding layer sections (e.g., layered sheets) as described herein.

As previously described herein, the plurality of layer sections for instance the first layer section, second layer section and the like operated on by the plurality of article manufacturing stations 202A-N (shown in FIG. 2) are stacked in a corresponding configuration with the scribing lines 402 (and corresponding seams 404, 406) of each of the article sections aligned and lying on top of each other. In another example, the scribing lines 402 and corresponding seams 404, 406 are not aligned. Instead, one or more of the article sections (400, 514 and so on) has a differing shape, size or the like relative to the other article sections to facilitate the assembly of different shapes such as for inflatable buildings, bridges, mats, liners or the like.

Referring again to FIG. 5B the article section stack 501 shows each of a plurality of first layer section 208, second layer section 216 and exemplary third, fourth, fifth and sixth layer sections 508-513. As shown each of the layer sections are comprised of upper and lower sheets. For instance the first layer section 208 includes a first sheet 500 and a second sheet 502. As previously described herein the cutting and joining assembly 110 joins the first and second sheets 500, 502 for instance along the scribing line 402. The first and second seams 404, 406 previously shown in FIG. 4 are provided again in FIG. 5B. The cutting (e.g., complete or perforated cutting) provided along the scribing line 402 is represented by the cut gap 512 also shown in FIG. 5B. After cutting and joining the first layer section 208, second layer section 216 and so on are formed into corresponding first, second, third, fourth, fifth and sixth exemplary pluralities of article sections 400, 514-522 as described herein. Each of these plurality of article sections are shown in an identical configuration (e.g., for a balloon or other consistent shape). In another example, as previously described herein, the article sections have differing shapes, sizes or the like for articles having varying shapes. The respective first and second sheets layered over each other, for instance first and second sheets 500, 502 of the first layer section 208, and are joined and cut along the same lines to accordingly form identical article portions for each of the layer sections. That is to say, the sheets of each layer section have identical cuts and joining configurations so that layered sheets have identical corresponding article portions layered over each other. In contrast, the upper and lower plurality of article sections 408A, B may have differing configurations according to variations in the scribing line pattern.

The first through sixth exemplary plurality of article sections 400-522 are provided in the stacked configuration shown in FIG. 5B. The stacked configuration allows for easy manipulation of the plurality of layer sections during assembly. For instance, one or more closing edge seals, manipulation of the plurality of joined article sections for packaging within a box or shipping container, or the like are facilitated with the stacked configuration of article sections having a consistent width as shown in FIG. 5B (e.g., the overall width of the article sections 400-522 when retained together equals the constant width of the corresponding layer sections). For instance the article section stack 501 has a substantially constant width (measured from left to right on the page) and length (extending into and out of the page) having predictable consistence edges and ends to thereby allow for easy manipulation and translation of the article section stack 501 through the article manufacturing system 200.

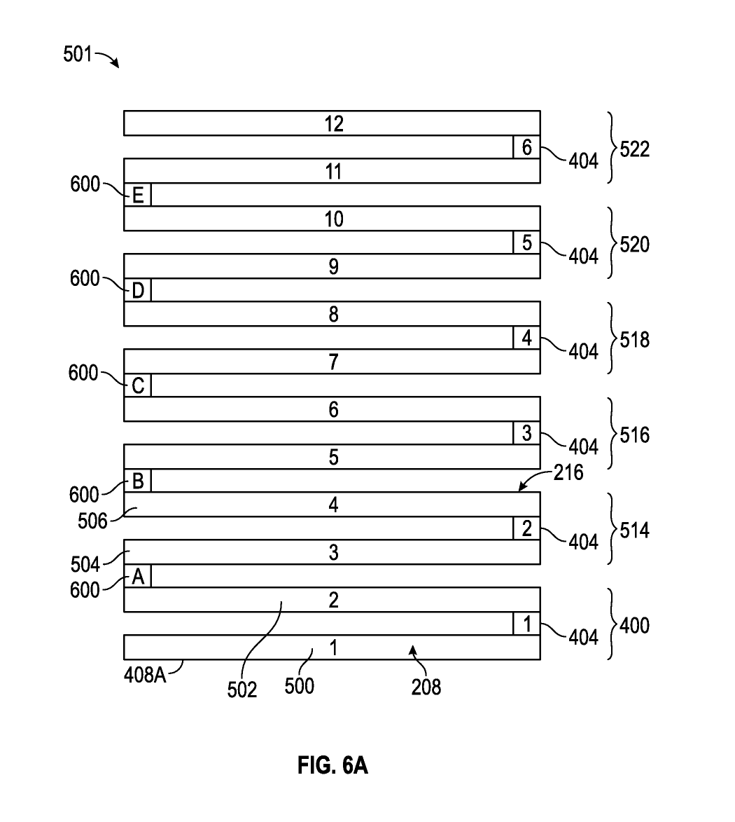

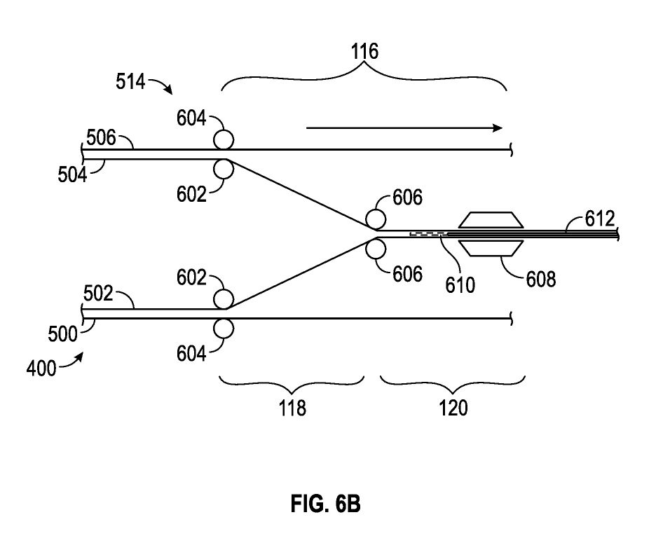

Referring now to FIG. 6A, the article section stack 501 is shown halved. As previously described herein the cut provided by the cutting and joining assembly 110 is either a complete or perforated cut to each of the sheets of each of the plurality of article sections 400-522 to generate dual articles from each of the upper and lower pluralities of article sections 408A, B.

The upper plurality of article sections 408A is shown in FIG. 6A divided from the lower plurality of article sections 408B to facilitate discussion of the edge seams 600. In practice, the first and second plurality of article sections 408A, B are readily retained together (e.g., with a perforated cut) to facilitate formation of the edge seams 600 at the same time. In another example, for instance where the upper and lower plurality of article sections 408A, 408B have differing configurations, one of the plurality of article sections is discarded or removed along the scribing line 402 and corresponding cut gap 512 (see FIG. 5B) for a differing portion of a manufacturing process.

Referring again to FIG. 6A, the upper plurality of article sections 408A are shown with the corresponding first seams 404 at each of the junctions of the first, second, third, fourth, fifth and sixth pluralities of article sections 400-522 along the scribing line 402 (see FIG. 5A, B). The first seams 404 join each of the first and second sheets of the respective article sections. For instance, the first layer section 208 includes first and second sheets 500, 502 joined at the first seam 404 while the corresponding second layer section 216 includes third and fourth sheets 504, 506 also joined at a corresponding first seam 404. Each of the pluralities of article sections 400-522 includes at least two sheets joined at the seams 404.

As further shown in FIG. 6A an edge seam 600 is provided for each of the first through sixth pluralities of article sections 400-522 to form an article assembly. As shown the edge seams 600 couple each sheet adjoining another sheet of an adjacent article section to accordingly provide a serpentine stacked configuration for the article section stack 501 (e.g., an article assembly of two or more joined article sections). In the example shown in FIG. 6A for instance, the first plurality of article sections 400 and the second plurality of article sections 514 are joined with a first edge seam 600 for instance provided by the edge joining assembly 218 previously shown in FIG. 2 and further described herein. The edge seam 600 couples the first and second pluralities of article sections 400, 514 at an edge opposed to the first seam 404.

In one example the first seam 404 is labeled a shape seam corresponding to the shape provided by the scribing line 402. In another example the edge seam 600 corresponds to a straight seam provided along the consistent linear edges of the constituent sheets of the article section stack 501. In yet other examples the edge seam 600 and interior seam such as the first seam 404 and second seams 406 are formed in a contrary manner for instance where the edge seam 600 has a nonlinear configuration and the interior seam 404, 406 has a linear or nonlinear configuration. As described herein the seams 404, 406 as well as the edge seams 600 are formed with one or more mechanisms including but not limited to the application of heat, adhesives, stitching, adhesive tapes, combinations of the same or the like.

Referring now to FIG. 6B one schematic example of a joining system to form the one or more edge seams 600 previously shown in FIG. 6A is provided. An edge joining assembly 116 (previously shown in FIG. 1) as shown in FIG. 6B includes in one example a separator 118 and an edge joiner 120. As will be described herein at least two edges of adjacent sheet, for instance the second and third sheets 502, 504 of the first and second pluralities of article sections 400, 514 are aligned (see FIGS. 5B and 6A). For instance the edges of the second and third sheets 502, 504 are aligned as a function of the stacking of the second layer section 216 (second plurality of article sections 514) over the first layer section 208 (first plurality of article sections 400). For instance, the second and third sheets 502, 504 include linear edges that are aligned as the first and second layer sections are guided together and stacked during the operation of each of the article manufacturing stations 202A and 202B (see FIG. 2). In another example the second and third sheets 502, 504 have aligned non-linear edges cut to the same pattern and layered together during operation of the first and second article manufacturing stations 202A, B.

One example of a separator 118 is shown in FIG. 6B. As the aligned edges are moved through the separator 118 a pair of separating rollers 602 allows for the division of each of the second and third sheets 502, 504 from their mating sheets the first sheet 500 and the fourth sheet 506, respectively. As shown the separator rollers 602 in combination with the joining rollers 606 guide the second and third sheets 502, 504 into a layered configuration (at least along their aligned edges) for operation of the edge joiner 120. The guide rollers 604 guide the first and fourth sheets 500, 506 while temporarily separated from the second third sheets 502, 504.

Referring again to FIG. 6B at least the edges of the second and third sheets 502, 504 are translated through the joining rollers 606 in an aligned configuration. The edges are fed through the edge joiner 120 including the edge joining head 608 shown in FIG. 6B to join the edges with one or more of a heat seal, stitching, adhesives, adhesive tapes or a combinations of the same. In one example, the edge joining head 608 is substantially similar to the cutting and joining head 304 previously shown and described in FIG. 3. Optionally the edge joining head 608 is without the cutting function of the cutting and joining head 304. Stated another way, the edge joining head 608 is configured to provide one or more seals (for instance including a second optional seal) to the edges of each of the second and third sheets 502, 504.

In another example the separating rollers 602 and joining rollers 606 include but are not limited to rollers configured to translate an interface feature configured to couple with the edges of the second and third sheets 502, 504. In one example the interface feature coupled between the separating and joining rollers 602, 606 includes a gripping chain. A gripping chain includes a series of rotatable linked chains including gripping features (clamps, engaging feet or the like) along each of the links. The gripping features grip the edges of the second and third sheets 502, 504 and guide the second and third sheets 502, 504 (their respective edges) through the edge joiner 120 including for instance a tendon liner 610 and the edge joining head 608. In yet another example, the separator 118 is a system for manipulation of at least the edges of two of the sheets including, but not limited to, one or more of the rollers described herein, transport chains including grip chains, vacuum rollers or vacuum conveyor, electrostatic handling features, combinations of the same or the like.

In another example, the edge joiner 120 includes a tendon applicator, such as a tendon liner 610. The tendon liner 610 cooperates with the edge joining head 608 to interlace a tendon 612 between each of the second and third sheets 502, 504 (e.g., along their aligned edges). The seams provided by the edge joining head 608 to couple the second and third sheets 502, 504 are provided on both sides of the tendon 612 to anchor the tendon and substantially prevent its translation from the desired lateral position at the edge seams 600 formed between the article sections.

The tendon 612 provides structural integrity to reinforce a sheet based article or inflatable device such as a balloon formed with a plurality of the article sections described herein. The tendon 612 provides supporting structure to a balloon article to ensure inflation of the balloon to a specified shape and size. In one example, the tendons 612 are pre-stressed at the time of application between the second and third sheets 502, 504 to accordingly ensure an article, such as a balloon, has a desired shape at full inflation.

In still another example, the tendon liner 610 applies one or more differing types of tendons 612 including, but not limited to, cords, ribbons, adhesive tapes, cables, flexible elements to the article sections at the edge joiner 120. Optionally, where the article sections (e.g., 400, 514) are formed from a tubular sheet that doesn't require edge seams, the tendon liner 610 is used alone to apply a tendon along 612 the article sections (e.g., by lapping portions of the article section over top of the tendon, applying a tendon tape or ribbon, or the like).

In yet another example, the tendon liner 610 applies the tendon 612 to the article sections, such as the article sections 400, 514, to improve handling and manipulation of the article sections and the finished article. For instance, where the article sections 400, 514 include a tendon 612 the tendon is optionally laced or fed into slots or other receiving features that grip and retain the tendons 612 and accordingly retain the article (or article sections). In this manner each of the article sections 400, 514 are easily handled during assembly, or the final article is easily handled during use or installation, for instance for installation of a liner article having tendons within a cavity including grooves for the tendons 612.

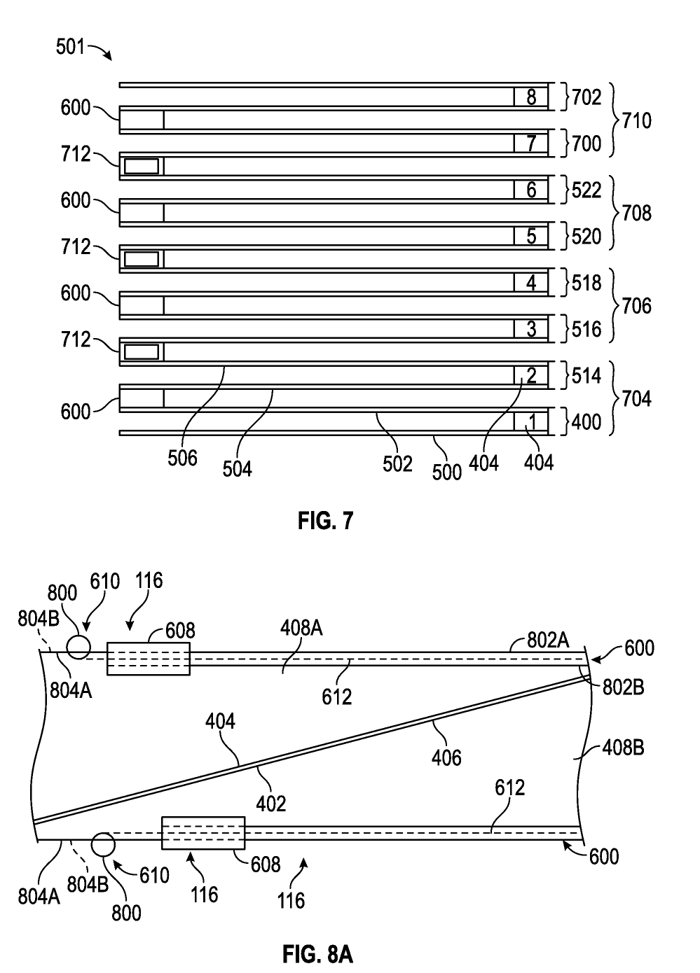

FIG. 7 shows another schematic example of an article section stack 501. The article section stack 501 includes each of the first, second, third, fourth and so on pluralities of article sections (e.g., 400, 514, 516, 518, 520 and 522). In the view shown in FIG. 7 an additional seventh and eighth plurality of article sections 700, 702 are also provided.

In one example, each of a pair of article sections are delivered through an edge joining assembly 116 similar in at least some regards to the edge joining assembly 116 shown in FIG. 6B. For instance, in the case of the first and second pluralities of article sections 400, 514 two or more aligned edges of each of the second and third sheets 502, 504 are delivered through the edge joiner 120 and joined to form an edge seam 600. When coupled at the edge seam 600 the first and second pluralities of article sections 400, 514 form a first article panel 704 (e.g., an article assembly of two or more article sections). In a similar manner the third and fourth pluralities of article sections 516, 518 are similarly joined with an edge seam 600 to form a second article panel 706. The edge seam 600 is duplicated to accordingly provide third and fourth article panels 708, 710. The article panels 704-710 are formed in one example as subassemblies used in one or more articles. As desired the article panels 704, 706, 708, 710 are selected (e.g., from warehouse containers, storage racks or the like) and stacked relative to one another to form the article section stack 501. In this configuration the article panels 704-710 are then joined for instance with panel seams 712. In one example the panel seams 712 are formed with the edge joining assembly 116. In another example, the panel seams 712 are formed with one or more hand joining tools including for instance sewing machines, adhesives, adhesive tapes, the application of heat to heat weld the sheets of the article panels and the like.

With the configuration of article panels 704-710 shown in FIG. 7 an operator may select one of a plurality of article panels 704-710 having either identical or different shapes, sizes, materials or the like to form one or more of a plurality of different resulting articles. As the article panels are assembled as specified they are stacked in a corresponding article section stack 501. The edges of the adjoining sheets of the article panels 704-710 are aligned when stacked and joined to form the panel seams 712. Accordingly a plurality of differing articles (e.g., balloons, aerostats, liners, tarpaulins, other sheet based articles and the like are constructed from a variety of on hand preassembled article panels 704-710 that are readily stacked and joined with panel seams 712.

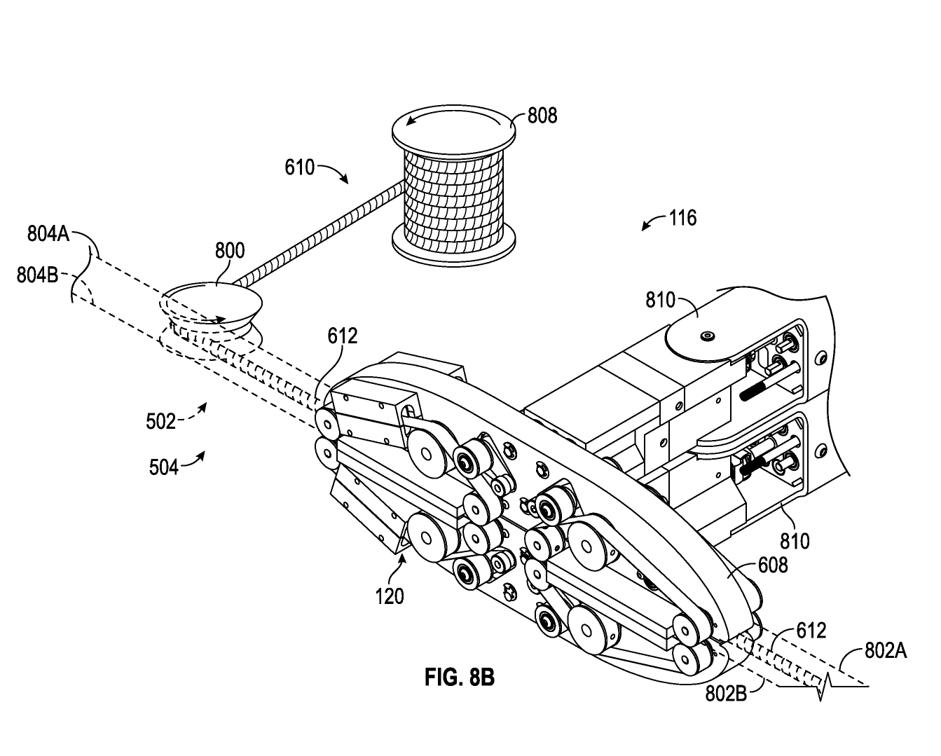

FIGS. 8A and 8B show one example of an edge joining assembly 116 in a top view (in contrast to the schematic side view of FIG. 6B). As previously described the edge joining assembly 116 provides one or more of the edge seams 600 shown in FIGS. 6A, B and 7. The example edge joining assemblies 116 shown in FIG. 8A include components of the edge joiner 120 shown in FIG. 6B including the edge joining head 608 as well as the tendon liner 610. As previously described the edge joining assembly 116 is configured to provide the edge seam 600 between each of the pluralities of article sections, for instance the first and second pluralities of article sections 400, 514 shown in FIG. 6A. The edge joining assembly 116 joins one or more aligned edges of the constituent sheets, such as the second sheet and third sheets 502, 504 of the respective first and second pluralities of article sections 400, 514. The article sections are joined to assemble a larger article including a plurality of the article sections. As described herein, the edge joining head 608 in one example is configured and operates similarly to the cutting and joining head 304. For instance, the edge joining head includes one or more joining mechanisms configured to provide the edge seams 600. One example of the joining mechanism includes, but is not limited to, one or more heating elements (resistive, infrared, cartridge heaters, convection and conductive heat transfer mechanisms, as well as ultrasonic and laser welders, adhesive applicators, adhesive tape applicators or the like) configured to heat an endless heating track or directly join the aligned edges with edge seams 600. The endless heating track engages with the article sections such as the sections 400, 514 to form the edge seams 600.

As previously described herein the pluralities of article sections (e.g., 400-522 or more) are joined while in a stacked configuration represented by the article section stack 501 previously shown in FIG. 6A (the stack 501 may contain fewer or more article sections than those shown). Referring now to FIG. 8A, the edge joining heads 608 of the edge joining assembly 116 are positioned downstream relative to the respective tendon liners 610. Each of the edge joining heads 608 forms at least one seam edge seam 600, and in one example forms inner and outer seams 802A, 802B corresponding to the edge seam 600. Where the application of a tendon 612 is specified the tendon 612 is interposed between the constituent sheets and each of the inner and outer edge seams 802A, 802B are formed on either side of the tendon 612 (e.g., at the aligned edge 804A, B).

As further shown in FIG. 8A, each of the upper and lower pluralities of article sections 408A, 408B are provided with an edge joining assembly 116 (e.g., the edge joining head 608 and the optional tendon liner 610). In another example where one of the pluralities of article sections 408A, 408B is discarded or used for other purposes (e.g., does not require an edge seam 600 or tendon 612) one or more of the edge joining assembly 116 or the tendon liner 610 is omitted from that side of the article sections.

As further shown in FIG. 8A, the tendon liners 610 are shown in upstream positions relative to the respective edge joining heads 608. As will be shown in further detail herein for instance in FIG. 8B the tendons 612 are interposed between each of two aligned edges 804A, B of the sheets of the corresponding pluralities of article sections prior to formation of the edge seams 600. For instance, as shown in FIG. 8A the tendon liner 610 includes a tendon applicator wedge 800 configured to spread the corresponding aligned edges of the sheets and position the tendon 612 therein. After positioning of the tendon 612 between the sheets the sheets are delivered through the edge joining head 608 (e.g., by way of the separator 118 previously shown and described in FIG. 6B). The edge joining head 608 provides the outer and inner edge seams 802A, 802B to accordingly retain the tendon 612 in the desired position along the article sections 408A, B.

FIG. 8B shows a perspective view of the edge joining assembly 116 including the edge joining head 608 and the tendon liner 610. In one example, the edge joining head 608 includes an articulating joint 810 to allow for rotational movement of the edge joining head 608, for instance along one or more nonlinear aligned edges corresponding to the edges 804A, 804B. In the example shown in FIG. 8B the aligned edges 804A, 804B have a substantially linear configuration and in such an example the articulating joint 810 is optional. The edge joining head 608 has features in common with the cutting and joining head 304 shown in FIG. 3 and further described in detail herein. As previously described, the edge joining head 608 is downstream from the tendon liner 610. For instance, the second and third sheets 502, 504 of the corresponding first and second plurality of article sections 400, 514 are fed first through the tendon liner 610 prior to formation of the outer and inner edge seams 802A, 802B of the edge seam 600 (See FIG. 8A).

FIG. 8B further shows the example tendon liner 610 in detail. The tendon liner 610 includes a tendon applicator wedge 800 positioned between each of the aligned edges 804A, 804B of the corresponding third sheet 504 and second sheet 502. In one example, the tendon applicator wedge 800 includes a pulley having a wedge shape that spreads the aligned edges 804A, 804B apart and positions the tendon 612 therebetween. The tendon 612 is fed from a tendon housing, for instance a tendon spool 808. The tendon spool feeds the tendon 612 to the tendon applicator wedge 800 according to rotation of the wedge 800 (e.g., rotating at a speed corresponding to the translation of the second and third sheets 502, 504).

After positioning of the tendon 612 between the third and second sheets 504, 502 (e.g., along the aligned edges 804A, 804B) the edge joining head 608 forms the outer and inner edge seams 802A, 802B. As shown in FIG. 8B, the outer and inner edge seams 802A, 802B retain the tendon 612 laterally. Accordingly, the tendon 612 is retained between the joined article sections (e.g., the first and second pluralities of article sections 400, 514).

In another example, where the tendon 612 is not specified the resulting article (composed of a plurality of article sections as described herein) the tendon applicator wedge 800 is withdrawn from the edge joining assembly 116 and one or more of the outer and inner edge seams 802A, 802B are optionally formed to provide the edge seam 600. For instance, in one example where a single seam is needed (without a tendon) either of the outer or inner edge seams 802A, 802B are formed to provide the edge seam 600. In another example where redundant or increased strength seams are desired the outer and inner edge seams 802A, 802B are both formed without the tendon 612 therebetween.

As previously described herein, in one example the edge joining head 608 includes an articulating joint 810. The tendon applicator wedge 800 is optionally coupled with the edge joining head 608 by way of an intervening plate or housing extending between the edge joining head 608 and the tendon applicator wedge 800. Accordingly, with articulation at the articulating joint 810 the tendon applicator wedge 800 continues to provide an interposing feature between the aligned edges 804A, 804B even where the aligned edges have a nonlinear configuration. That is to say, the articulating joint 810 articulates both the edge joining head 608 as well as the tendon applicator wedge 800 relative to the nonlinear edges of the second and third sheets 502, 504 to thereby ensure the application of the tendon 612 therebetween.

In still another example, for instance with an article section (or sections) that do not require an edge seam 600, the tendon liner 610 applies the tendon 612 along a portion of a respective article section. For instance, the tendon 612 is an adhesive tape or ribbon that is adhered, stitched or the like to the article section. In another example, a portion of the article section is folded over the tendon 612 with a creasing feature, such as the tendon applicator wedge 800 engaged with the article section. The crease formed by the tendon applicator wedge 800 receives the tendon and folds the article section over itself to allow for joining of a portion of the article section (on the crease) with another portion of the article section. In one example, a joining assembly similar to the edge joiner 120 closes the crease around the tendon 612, for instance, with the application of heat, stitching, adhesives, laser or ultrasonic welding or the like.

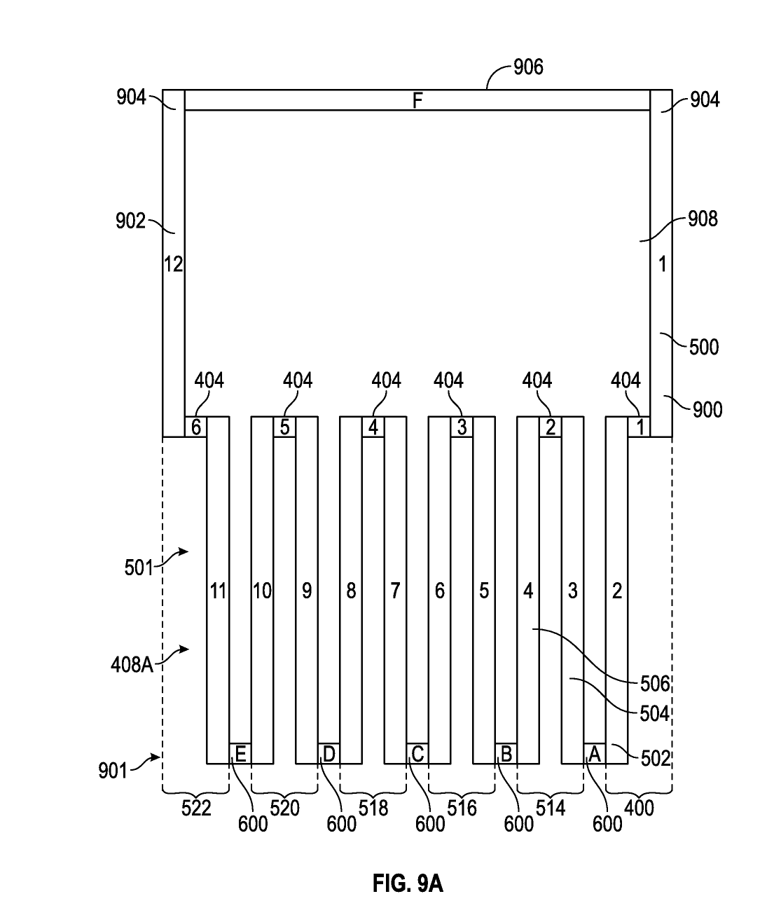

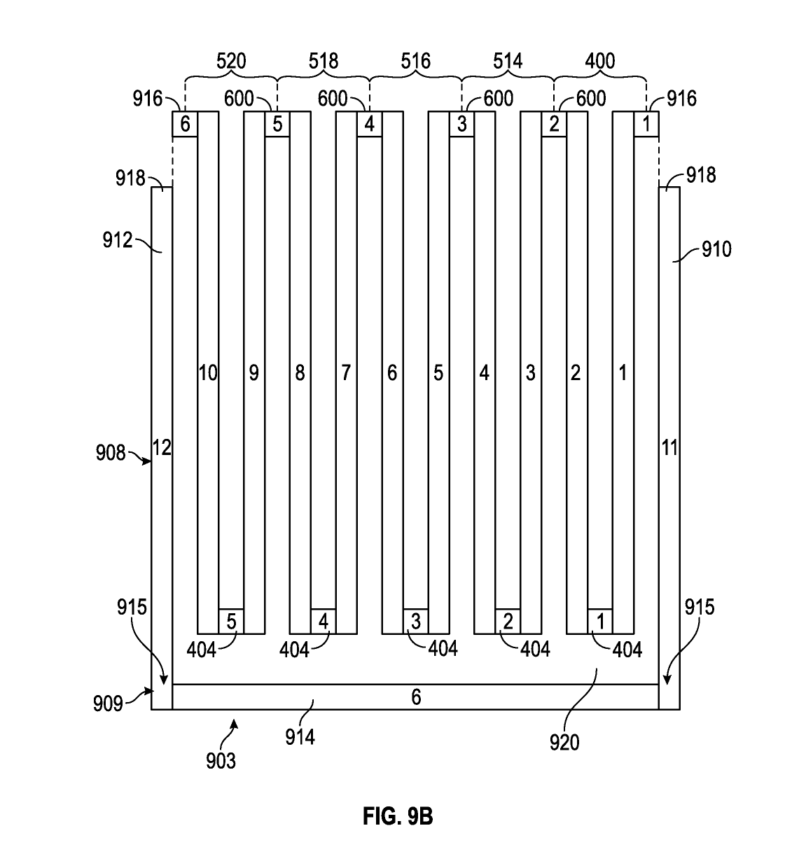

FIG. 9A shows the article section stack 501 previously described herein (corresponding to the upper plurality of article sections 408A shown for instance in FIG. 4) in a vertical orientation. As shown, the article section stack 510 is closed with a closing seam 906 to form an article 901, such as a balloon. The article section stack 501 corresponding to the upper plurality of article sections 408A is separated from a corresponding lower plurality of article sections 408B (FIG. 4) and then reoriented with each of the sheets of the corresponding first through sixth exemplary pluralities of article sections 400-522 in the vertical orientation. Stated another way, the edge seams 600 joining each of the pluralities of article sections are provided at the relative lower portion of the article section stack 501 while the first seams 404 (e.g., along the scribing line 402 in FIG. 4) are provided at the relative upper portion of the article section stack 501.

In the configuration shown in FIG. 9A each of the first and last sheets of the article section stack 501 are joined at a closing seam 906. In the example shown in FIG. 9A the closing seam 906 is formed with the first sheet 500 of the first plurality of article sections 400 and a second sheet of the corresponding sixth plurality of article sections 522. As shown in FIG. 9A, the first sheet 500 corresponds to the first end sheet 900 and the final end sheet of the sixth plurality of article sections 522 corresponds to the second end sheet 902. Stated another way the first and second end sheets 900, 902 form the first and final sheets of the article section stack 501 (having any number of stacked pluralities of article sections).

In one example, in the vertical orientation the first and second end sheets 900, 902 are manipulated with one or more of a gripping chain (previously described herein), a conveyor assembly, a separator assembly, such as the separating and joining rollers 602, 606 (see FIG. 6B) or the like. The manipulation of the first and second end sheets 900, 902 pulls the first and second end sheets 900, 902 into a substantially vertical orientation with the closing edges 904 positioned adjacent to one another. The view shown in FIG. 9A provides the closing edges 904 in an exaggerated spaced configuration to show the closing seam 906. The closing seam 906 is provided between the closing edges 904 with an edge joining assembly, such as the edge joining assembly 116 shown in FIGS. 1 and 8B. In one example the edge joining assembly 116 includes an edge joining head 608 as shown in FIG. 8B and a tendon liner 610.

As shown in FIG. 9A, after provision of the closing seam 906 and an optional tendon 612 positioned along the closing seam 906 the article section stack 501 is closed and the article 901 is formed. That is to say, a cavity 908 is formed within the interior perimeter of the article section stack 501. In one example, with a plurality of article sections, such as the article sections 400-522, the closed cavity 908 provides the cavity for a balloon, the interior of a ballonet, a closed sheet based article or the like. Accordingly, with closing of the upper and lower ends of the article section stack 501 (corresponding to the ends of the article section stack coming into and out of the page) a full balloon is formed. In another example, the article section stack 501 is left open at its ends to thereby provide a cylindrical article, such as a liner, for use within a structure such as a tank, reservoir or the like.

FIG. 9B shows another example of a closed article section stack 908 including pluralities of article sections, such as the article sections 400-520 previously described herein. As shown in FIG. 9B, the pluralities of article sections 400, 514, 516, 518, 520 are arranged in a substantially vertical fashion with each of the corresponding sheets of the article sections arranged vertically. As shown, the first seams 404 of each of the plurality of article sections are provided at the relative lower portion of the article section stack 908. The edge seam 600 joining each of the pluralities of article sections together are provided at the relative upper portion of the article section stack 908.

As further shown in FIG. 9B, the article section stack 908 includes a closing article section 909 positioned around a portion of the remainder of the article section stack 908 including the plurality of article sections 400-520. As shown, the closing article section 909 includes a first end sheet 910 and a second end sheet 912. The first and second end sheets 910, 912 are joined along a closing seam 914 (exaggerated for the schematic view). In one example, the closing seam 914 is formed with an edge joining assembly, such as the edge joining assembly 116 previously described and shown in FIGS. 1 and 8B. For instance, in one example the edge joining assembly 116 includes an edge joining head 608 and an optional tendon liner 610 that provides a tendon 612 between each of the aligned edges 915 of the first and second end sheets 910, 912.

Stated another way, the closing article section 909 is closed with the closing seam and forms a pocket for reception of the remainder of the article section stack 908. Optionally, the article manufacturing system 200 includes a manipulation mechanism to open the closing article section 909 for reception of the pluralities of article sections 400-522. The manipulation mechanism includes, but is not limited to, one or more of a series of rollers (described herein for the separator 118), one or more gripping chains or the like to manipulate the closing article section 909 and open it for reception of the vertically oriented remainder of the article section stack 908 including the pluralities of article sections 400-520.

As further shown in FIG. 9B, the closing article section 909 includes closing edges 918 positioned to either side of each of the pluralities of article sections 400-520. The closing edges 918 are joined with the corresponding edges of the most exterior sheets of each of the plurality of article sections 400-520. The closing edges 918 are aligned with the corresponding edges of the sheets and joined at an edge seam 916. In one example the edge seam 916 is formed in a substantially similar manner to the edge seam 600. For instance an edge joining head, such as the edge joining head 608, is optionally used in combination with the tendon liner 610 to provide a dual seam with outer and inner edge seams 802A, 802B holding the tendon 612 therebetween. As previously described herein the tendon liner 610 is optional. Accordingly, the edge seam 916 may have one or both of the outer and inner edge seams 802A, 802B to form the corresponding edge seam 916.

In another example, the first and second end sheets 910, 912 have a larger width than the constituent sheets of the plurality of article sections 400-520 to provide additional room for reception of the remainder of the article section stack 908 within the closing article section 909 and to facilitate manipulation and alignment of the closing edges 918 with the first and second end sheets of the pluralities of article sections 400, 520. After formation of the edge seam 916 and manipulation of the first and second end sheets 910, 912 is no longer needed the excess of the first and second end sheets 910, 912 is optionally trimmed from the article.

As previously described with regard to FIG. 9A, with completion of the closing edges 918 an article 903 is formed with a continuous outer perimeter and a closed cavity 920 therein. In one example, the closed cavity corresponds to the cavity of a balloon article. In yet another example, the cavity 920 corresponds to the inner cavity of a sheet based article, for instance a liner for a tank, reservoir or the like.

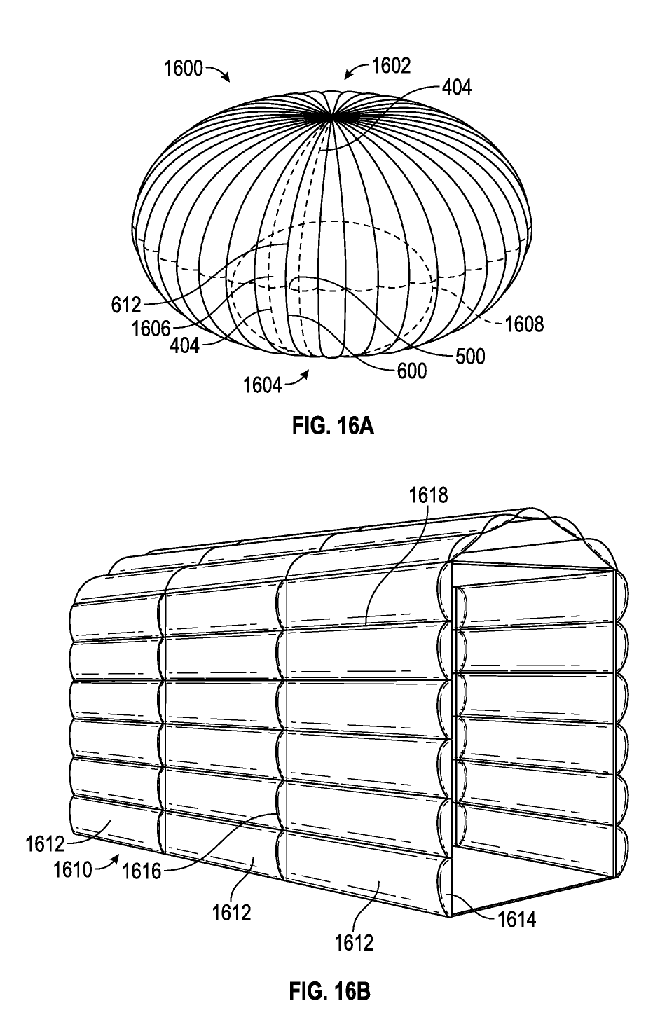

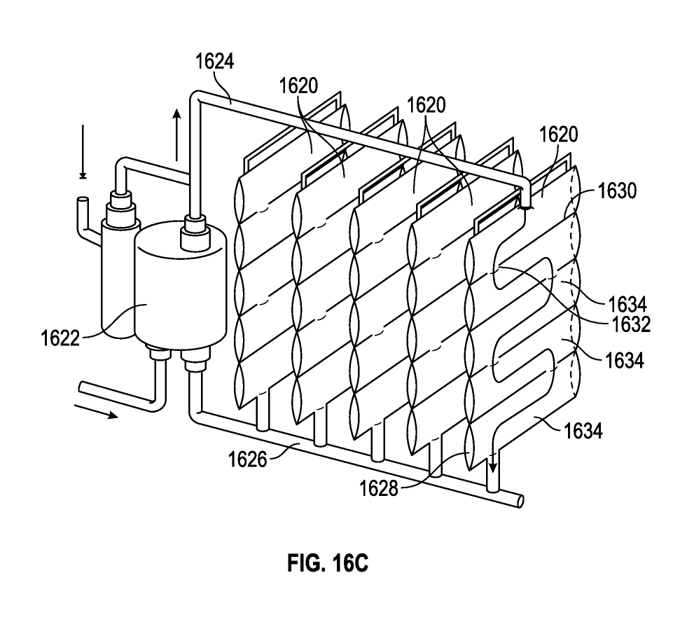

With regard to either of the examples shown in FIGS. 9A and 9B the provision of a closing seam 906, 914 is optional. The article manufacturing system 200 as part of the article assembly line 100 described herein may optionally generate an article 901, 903 corresponding to a balloon or other closed perimeter article. In another example, the article manufacturing system 200 of the article assembly line 100 is used to generate sheet based articles including, but not limited to, single ply or double ply sheet based articles having a closed or open configuration. Stated another way, the systems and methods described herein (e.g., for use in the article assembly line 100 and the article manufacturing system 200) are configured to automate the assembly and manufacture of balloon articles having a variety of sizes and shapes. In other examples the assembly line 100 and the article manufacturing system 200 provide automated mechanisms that generate non-balloon articles, examples of which are provided herein (see FIGS. 16A-C and the associated description).

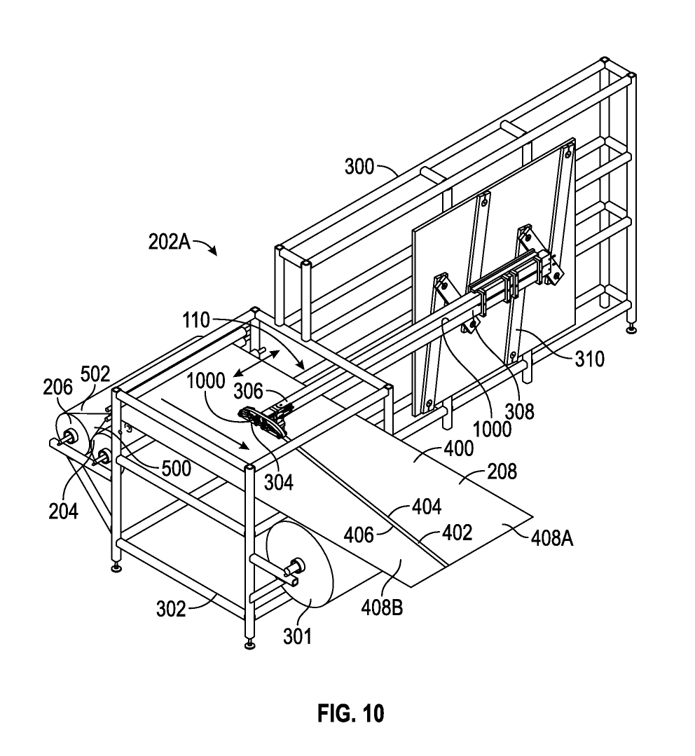

FIG. 10 shows one example of the article manufacturing station 202A (e.g., previously shown in FIG. 3). In one example, the article manufacturing stations 202B-N shown in FIG. 2 have the same or similar construction to the station 202A. The article manufacturing station 202A includes an assembly frame 302 and an arm frame 300. The cutting and joining assembly 110 extends through the assembly frame 302 and interacts with a layer section such as the first layer section 208 (or layered sheet) extending through the assembly frame 302. As shown in the example in FIG. 10, the first layer section 208 includes first and second sheets 500, 502 fed from the first and second sheet housings 204, 206. The first and second sheet sheet housings 204, 206 include, but are not limited to, rollers or spools including a continuous or lineal length of the first and second sheet materials. In another example the first and second sheet housings 204, 206 include other sheet or film feeding mechanisms including extruders, such as the extruders 106 previously shown in FIG. 1.

As further shown in FIG. 10 the arm frame 300 provides a translation mechanism 310 coupled with an assembly arm 308. As previously described the assembly arm 308 is in turn coupled with the cutting and joining head 304 for instance by way of an articulating joint 306. The translation mechanism 310 as described herein includes a series of bar mechanisms configured to maintain the assembly arm 308 at a substantially static elevation allowing for translation of the assembly arm 308 and the cutting and joining head 304 in a reciprocating manner for instance across the first layer section 208. The translation mechanism 310 is coupled with the arm frame 300 and the arm frame 300 is in one example coupled with the assembly frame 302.

As shown in FIG. 10, the first layer section 208 (e.g., the second sheet 502 layered over the first sheet 500) translates through the assembly frame 302 for instance between upper and lower portions of the cutting and joining head 304, the articulating joint 306 and the assembly arm 308. For instance, an article gap 1000 is provided between each of these features to accordingly allow for translation of the first layer section 208 between these features.

As previously described herein, the cutting and joining head 304 is articulated, for instance with the articulating joint 306, while the assembly arm 308 moves the head 304 to accordingly allow for rotation of the cutting and joining head 304 during translation. The moving cutting and joining head 304 forms the first plurality of article sections 400. For instance the cutting and joining head 304 moves (above and below) relative to the translating first layer section 208 and correspondingly joins the first and second sheets 500, 502 along the scribing line 402. The scribing line 402 is a virtual line drawn by the moving cutting and joining head 304 as the first layer section 208 translates relative to the head. As shown, first and second seams 404, 406 extend on either side of the scribing line 402 and accordingly form seams for each of upper and lower pluralities of article sections 408A, 408B.

In another example, the cutting and joining head 304 includes a cutting section configured to cut the first layer section 208 between each of the seams 404, 406 (and along the scribing line 402). In one example the cut is a continuous cut that divides the upper and lower pluralities of article sections 408A, 408B. In still another example, the cutting section of the cutting and joining head 304 provides a perforated cut along the scribing line 402 to allow for retention (later separable) of each of the upper and lower pluralities of article sections 408A, 408B to facilitate the handling of the first layer section 208 during assembly of the article (e.g., for layering with supplemental layer sections as previously described herein). Stated another way the maintenance of a connection between the upper and lower pluralities of article sections 408A, 408B provides a consistent linear width to the first layer section 208 and accordingly facilitates the mating of second and subsequent layer sections over top thereof and readily allows for corresponding of the scribing lines 402 of each of those layer sections to the scribing line 402 and the first layer section 208.

As previously described herein, in one example the scribing line 402 provides a series of staggered article sections as shown in the overall view provided in FIG. 5A. For instance, referring to FIG. 5A the scribing line 402 angles back and forth between the equators 503 in a wave-like pattern. Accordingly, each of the upper and lower pluralities of article section 408A, 408B have an identical configuration that is staggered.

In another example, the upper and lower pluralities of article sections 408A, 408B are distinct. For instance the scribing line 402 (seams 404, 406 and the cut line) is provided on the first layer section 208 in a nonlinear or variable pattern to accordingly provide different upper and lower pluralities of article sections 408A, 408B that are not staggered mirror images. For instance, in one example one of the upper and lower plurality of article sections 408A, 408B is used as part of a larger article section. The remainder (either of the remaining upper or lower pluralities of article sections 408A, B) not used is discarded from the final assembled article. In yet another example, each of the upper and lower pluralities of article sections 408A, 408B whether identical or not are generated to accordingly provide article sections for dual articles. That is to say, each of the upper and lower pluralities of article sections 408A, 408B are both used for differing portions of two articles. Accordingly, where the upper and lower pluralities of article sections 408A, 408B are each used for one or more articles there is substantially no waste (e.g., minimal or negligible waste) from the article manufacturing station 202A (and each of the inline counterpart stations 202B-N).

As previously described herein, duplicates of the article manufacturing station 202A are provided in sequence in the article manufacturing system 200 (FIG. 2). The provision of multiple article manufacturing stations 202A-N allows for the layering of a plurality of layer sections to then facilitate the joining of edges to assemble larger articles having multiple article sections. Any number of article manufacturing stations 202A-202N are assembled in line to accordingly produce articles of any size corresponding to both the size of the material fed through each of the article manufacturing stations 202A-N as well as the number of article manufacturing stations 202A-N (and corresponding article sections generated by each).

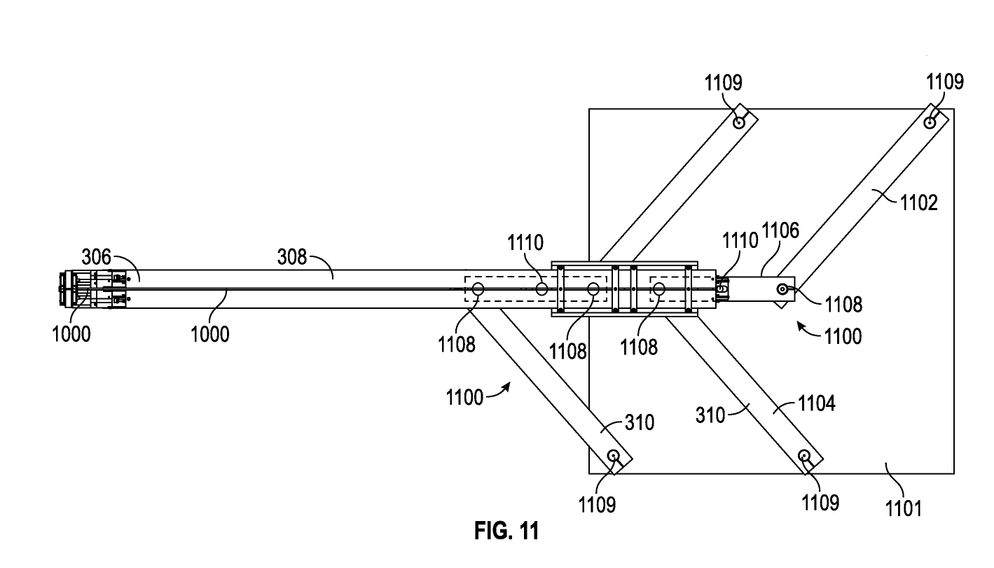

FIG. 11 shows another example of a portion of the article manufacturing station 202A. The assembly arm 308 including the articulating joint 306 is shown coupled with the translation mechanism 310. In the example shown, the translation mechanism 310 includes one or more bar mechanisms 1100 coupled with the assembly arm 308. The one or more bar mechanisms 1100 optionally span the upper and lower portions of the assembly arm (on either side of the article gap 1000). In another example, the bar mechanisms 1100 are coupled with a carriage of the assembly arm 308 coupled between each of the upper and lower portions of the assembly arm.

As shown, each of the bar mechanisms 1100 in this example includes a first bar 1102 and a second bar 1104 with an intervening intermediate bar 1106 coupled by way of pivot joints 1108. In one example each of the first and second bars 1102, 1104 are coupled with a frame substrate of the arm frame 300 by pivot joints 1109. As shown in FIG. 11, the arm substrate 1101 is in one example a plate coupled across the arm frame 300 to provide one or more anchor points for the pivot joints 1109 of each end of the first and second bars 1102, 1104.

As further shown in FIG. 11, each of the intermediate bars 1106 is coupled with the first and second bars 1102 at the respective pivot joints 1108. For instance, the intermediate bar 1106 is rotates and translates with each of the first and second bars 1102, 1104 as the first and second bars are reciprocated (e.g., rotated relative to the pivot joints 1109). In one example the intermediate bar 1106 includes a arm pivot point 1110. The arm pivot point 1110 provides an interface between the assembly arm 308 and the bar mechanisms 1100. The arm pivot points 1110 for each of the bar mechanisms 1100 are substantially vertically static during translation of the bar mechanisms 1100 forward and backward (from left to right in FIG. 11). That is to say, the intermediate bars 1106 rotate relative to the arm pivot points 1110 or rotate about the arm pivot points 1110. However, the arm pivot points 1110 remain elevationally (vertically) static to allow the assembly arm 308 to accordingly remain vertically static. Similarly, the article gap 1100 having the first layer section 208 therein remains substantially vertically because the assembly arm 308 is vertically static. Accordingly, the first layer section 208 is able to freely move between the assembly arm portions 308 as well as the articulating joint 306 and the cutting and joining head 304 without interference by vertical movement of the assembly arm 308 lifting and lowering the first layer section 208. Stated another way, the first layer section 208 is able to freely move through the assembly arm 308, the articulating joint 306 and the cutting and joining head 304 without vertical movement of either of the assembly arm 308, the cutting and joining head 304 or the articulating joint 306.

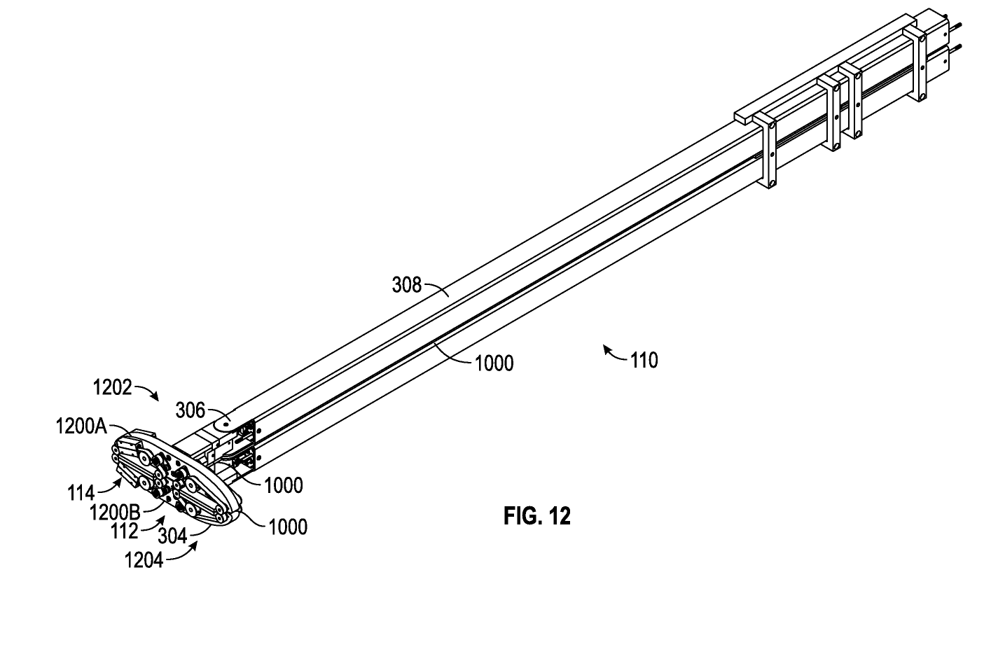

Referring now to FIG. 12, a perspective view of the cutting and joining assembly 110 is provided. As previously described, the cutting and joining assembly 110 includes in an example an assembly arm 308 coupled with an articulating joint 306, and the articulating joint 306 is in turn coupled with the cutting and joining head 304. One example of the cutting and joining head 304 is shown in FIG. 12. Each of the cutting and joining head 304, the articulating joint 306 and the assembly arm 308 include an article gap 1000. As described herein, the article gap 1000 facilitates the translation of one or more sheets (e.g., of a layered sheet such as the first layer section 208) through the cutting and joining assembly 110.

The cutting and joining head 304 includes upper and lower head portions 1200A, 1200B provided above and below the first layer section 208 (and the article gap 1000) during operation of the article manufacturing station 202A. Similarly, the articulating joint 306 and the assembly arm 308 are also divided by the article gap 1000 into upper and lower portions. Each of the upper and lower head portions 1200A, 1200B are able to move over top of and below the first layer section 208 and correspondingly articulate (remain aligned with each other) relative to the assembly arm 308 during operation of the cutting and joining assembly 110.

In one example, one or more of the upper and lower head portions 1200A, 1200B includes a joining section 114. The joining section 114 as described herein includes one or more elements configured to join each of the first and second sheets such as the first and second sheets 500, 502 of the first layer section 208. In another example, both of the upper and lower head portions 1200A, 1200B include joining sections 114. Accordingly the joining sections 114 in such an arrangement are configured to each provide heat to the opposed sheets 500, 502 to thereby join the opposed sheets with at least one of the first and second seams 404, 406 provided along the scribing line 402.

As will be further described herein, the cutting and joining head 304 includes an inboard side 1202 and an outboard side 1204. In one example, one or more of the upper and lower head portions 1200A, 1200B each include dual joining sections provided on the inboard and outboard sides 1202, 1204 of the cutting and joining head 304. As shown in FIG. 12, the inboard side 1202 of the cutting and joining head 304 is provided adjacent to the articulating joint 306 and the assembly arm 308. Optionally, the inboard side 1202 includes its own joining section 114 whether on one or both of the upper and lower head portions 1200A, 1200B. In a similar manner, the outboard side 1204 (positioned relatively away from the articulating joint 306) is provided with its own one or more joining sections 114 on one or both of the upper and lower head portions 1200A, 1200B. The joining sections 114 positioned on both the inboard and outboard sides 1202, 1204 allow for the provision of first and second seams, such as the first and second seams 404, 406 shown in FIG. 10.

The articulating joint 306 allows for rotation of the cutting and joining head 304, for instance to follow a specified pattern on layered sheets such as the first section layer 208. In one example, the articulating joint 306 includes one or more a hinge joint, ball and socket joint, living hinge or the like. The cutting and joining head 304 is articulated about the articulating joint with one or more of the following articulation mechanisms (actuators) including, but not limited to, actuators coupled at the joint 306 or between the cutting and joining head 304 and the assembly arm 308. In still other examples, the cutting and joining head 304 is articulated about the articulating joint 306 with actuators including, but not limited to, opposed or cooperating rack and pinion mechanisms (on opposed sides of the joint), swing panels, ball screw mechanisms, linear motors (singly or on opposed sides of the joint 306), belt and pulley mechanisms with the pulley on the head 306 and rotated by the belt, or the like.

As further shown a cutting section 112 is also provided with the cutting and joining head 304. The cutting section 112 cuts the first layer section 208, for instance along the scribing line 402. The function of the cutting section 112 is consolidated with the function of the joining sections 114. For instance, in one example each of the first and second seams 404, 406 are formed while at nearly the same time the cutting section 112 cuts the first layer section between the first and second seams 404, 406. Accordingly the cutting and joining head 304, with one or more of translation of the assembly arm 308 or articulation of the cutting and joining head 304 with the articulating joint 306, is able to provide consolidated seams and cut along the scribing line 402.

In one example, the cutting section 112 includes a blade or other feature configured to rotate or remain static at a position between the upper and lower head portions 1200A, 1200B and at least partially within the article gap 1000. In an example, the blade is held between dual joining sections 114, for instance provided on the inboard and outboard sides 1202, 1204. That is to say, the cutting section 112 provides a cutting element that accordingly cuts along the scribing line 402 in between the first and second seams 404, 406 (see FIG. 10) formed with the dual joining sections.

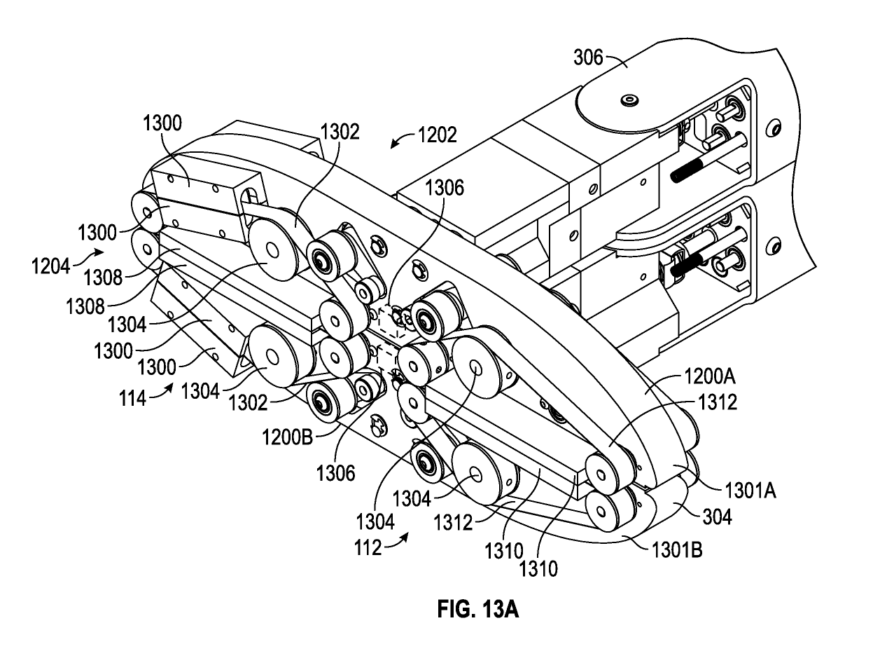

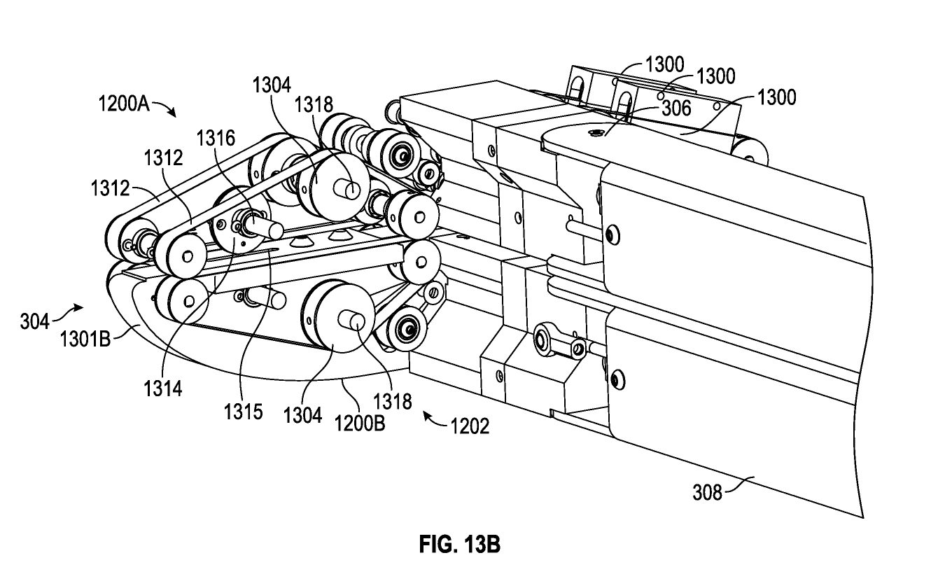

FIG. 13A shows the outboard side 1204 of the cutting and joining head 304 previously shown in FIG. 12. As previously described, the cutting and joining head 304 includes a cutting section 112 and a joining section 114. In the example shown in FIG. 13A the joining section 114 is upstream relative to the cutting section 112 (at a downstream side). The upstream and downstream sides are relative to the translational movement of a layer section, for instance the first layer section 208 as shown in FIG. 10. Accordingly the joining session 114 is positioned at the upstream side of the first layer section 208 while the cutting session 112 is positioned at the downstream side. In another example the positions of the cutting section 112 and joining section 114 are reversed, for instance the cutting section 112 is upstream relative to the cutting and joining head 304.

Referring again to FIG. 13A, as shown the cutting and joining head 304 includes the upper and lower head portions 1200A, B having corresponding upper and lower head housings 1301A and 1301B. The housings 1301A, B and the head portions 1200A, B are spaced apart by the article gap 1000 to facilitate the movement of a layered sheet (section layer) therebetween. Referring first to the upper head housing 1301A, in the example shown in FIG. 13A the upper head housing includes dual joining sections 114 on the inboard and outboard sides 1202, 1204. For instance each of the inboard and outboard sides 1202, 1204 include one or more heating elements 1300 configured to provide heat to the first layer section 208. The heating elements 1300 heat the first layer section 208 including the first sheet 500 and the second sheet 502 to accordingly form each of the first and second seams 404, 406. In one example the heating element 1300 on the outboard side 1204 forms the second seam 406 while the heating element 1300 (partially concealed by the upper head housing 1301A) forms the first seam 404. The heating elements 1300 include, but are not limited to resistive heaters, infrared heaters, cartridge heaters, convection and conductive heat transfer mechanisms or the like configured to heat the endless heating tracks 1302 or directly heat the sheets of the layer sections (e.g., the first layer section 208). Optionally, the heating elements include other joining mechanisms including, but not limited to, adhesives, adhesive tapes, ultrasonic welders, laser welders or the like.

As shown in the example provided in FIG. 13A the heating elements 1300 each heat a respective endless heating track 1302 extending around corresponding rollers extending from the upper head housing 1301A. For instance, the plurality of rollers include a drive roller 1304 rotatably coupled with the housing 1301A. In the example where the joining section 114 includes dual joining sections 114 on the inboard and outboard sides 1202, 1204 at least one heating element 1300 is provided for each of the respective endless heating tracks 1302. In the example shown in FIG. 13A, each of the inboard and outboard sides 1202, 1204 includes dual heating elements 1300 sandwiching a portion of the endless heating track 1302 therebetween. For instance, the heating elements 1300 are directed at each of the opposed sides of the endless heating track 1302 and accordingly provide even heating across the endless heating track 1302.

As further shown in FIG. 13A in one example the endless heating tracks 1302 extend between heating platens 1308. The heating platens 1308 provide a contoured feature to ensure a substantially planer engagement of the endless heating tracks 1302 with the corresponding portions of the first layer section 208 for formation of the first and second seams 404, 406. Stated another way, the heating platens 1308 bias the endless heating track 1302 into engagement along the first layer section 208 (e.g., along one or more of the first and second sheets 500, 502) to thereby provide consistent and thorough heating to form each of the first and second seams 404, 406.

In one example the endless heating tracks 1302 move in correspondence with the first layer section 208. For instance the driver roller 1304 is rotated at a speed configured to ensure the endless heating track 1302 moves at substantially the same speed as the first layer section 208. Accordingly sliding and slipping engagement between the endless heating track 1302 and the first layer section 208 is substantially avoided.

As further shown in FIG. 13A, in one example each of the upper and lower head portions 1200A, 1200B each includes a joining section 114. For instance each of the upper and lower head portions 1200A includes one or more heating elements 1300 and corresponding endless heating tracks 1302. Accordingly, at each of the inboard and outboard sides 1202, 1204 the opposed heating elements 1300 and corresponding opposed endless heating tracks 1302 and platens 1308 each engage with one of the first and second sheets 500, 502 of the first layer section 208 to accordingly form one of the seams 404, 406 with heating of both sides of the first section layer.

In another example, the inboard side 1202 of the cutting and joining head 304 also includes dual opposed heating elements 1300 and endless heating tracks 1302. Accordingly the upper and lower head portions 1200A, 1200B in such an example include four endless heating tracks 1302, and as shown in FIG. 13A eight heating elements 1300 (each of the endless heating tracks 1302 including two opposed heating elements 1300). In such an example each of the first and second sheets 500, 502 are configured to receive heating by way of the endless heating tracks 1302 facing the respective sheets along the inboard and outboard sides 1202, 1204 (for the seams 404, 406).

Optionally, temperature sensors 1306 (e.g., one or more sensors) are provided downstream from the joining sections 114. In one example, the temperature sensors 1306, include, but are not limited to pyrometers, thermocouples, resistive heat sensors or the like. The temperature sensors 1306 face the first layer section as it travels through the cutting and joining head 304. The temperature sensors 1306 measure the temperature of the first layer section immediately after formation of the seams 404, 406 by the joining sections 114. In one example, the temperature sensors communicate with a feedback controller configured to control the heat input applied by the heating elements 1300 to the endless heating belts 1302 according to feedback control.

Cooling platens 1310 are also shown in FIG. 13A downstream from the joining section 114 and near the cutting section 112. The cooling platens 1310 are provided in an opposed fashion (on either side of the article gap 1000 shown in FIG. 10) along the upper head portion 1200A and the lower head portion 1200B. As shown in FIG. 13A, each of the cooling platens 1310 extends from the respective upper and lower head housings 1301A, 1301B. In one example the cooling platens 1310 are configured to slidably engage with the first layer section 208 including the first and second sheets 500, 502 to cool the sheets prior to translation of the first and second seams 404, 406 out of the cooling and joining head 304. Accordingly the cooling platens 1310 set the seams 404, 406 prior to the first layer section 208 leaving the cutting and joining head 304. Stated another way the cooling platens 1310 are positioned downstream from the respective joining sections 114 and fix each of the first and second seams 404, 406 provided by the joining sections 114 prior to translation of the first layer section 208 out of the cutting and joining head 304.

The cooling platens 1310 in one example are constructed with materials having relatively high specific heats including, but not limited to, brass, copper or the like that facilitate conductive heat transfer from the joined layered sheets (e.g., the first layer section 208). In another example, the cooling platens 1310 include one or more nozzles, an array of perforations or the like configured to provide convective heat transfer (e.g., with negligible or no contact of the platen 1310 to the layered sheets). For instance, forced gas such as cooled air, carbon dioxide or the like is applied through the nozzles or performations to cool the joined portions (seams 404, 406) of the first section layer 208. In still another example, the cooling platens 1310 are liquid cooled jackets that provide heat transfer from the first section layer 208 to the cooled liquid. Optionally, the cooling platens 1310 act include nozzles or ports that provide a cooled fluid mist to the first layer section 208 include the joined seams 404, 406.

A further shown in FIG. 13A, in one example the cutting section 112 also includes a plurality of endless tracks 1312. In a similar manner to the endless heating tracks 1302 the endless tracks 1312 are driven by drive rollers 1304 and are configured to move at substantially the same speed as the translating first layer section 208. Accordingly, the endless tracks 1312 facilitate the movement of the first layer section 208 through the cutting and joining head 304 without slipping, bunching or the like between the upper and lower head portions 1200A, 1200B. Additionally, the endless tracks 1312 facilitate the movement of the first layer section 208 including each of the previously heated and joined first and second sheets 500, 502 through the cooling platens 1310 to thereby facilitate cooling of the first and second seams 404, 406.

FIG. 13B shows the inboard side 1202 of the cutting and joining head 304 previously shown in FIG. 13A. In the example shown in FIG. 13B the upper head housing 1301A is removed to reveal the rotating cutting element 1314 therein. As shown in the example of FIG. 13B a rotating cutting element 1314 for instance a rotatable cutting blade, discontinuous cutting blade, multi blade cutting assembly or the like is provided within the upper head portion 1200A. In one example, the upper head portion 1200A includes a rotating cutting element 1314 and the lower head portion 1200B includes an opposed rotating cutting element 1314. In yet another example the upper head portion or lower head portion 1200A, 1200B includes a rotating cutting element 1314 while the other of the head portions 1200A, 1200B is without such a cutting element and instead includes an optional anvil 1315 configured to provide a supporting surface to a layered sheet during cutting (for an accurate consistent cut line). In yet another example a cutting element of the cutting and joining head 304 is a static cutting element for instance a straight blade or the like extending out of the upper or lower head portions 1200A, 1200B to cut sheets, such as the first and second sheets 500, 502, between the upper and lower head portions 1200A, 1200B.

In the example with a rotating cutting element 1314 the rotating cutting elements 1314 extend through grooves or other openings of the upper and lower head housings 1301A, 1301B and are rotated to cut the first layer section 208 including the first and second sheets 500, 502. In the example with the rotating cutting element 1314 provided in one of the upper or lower head portions 1200A, 1200B the rotating cutting element 1314 is projected sufficiently from either of the upper or lower head portions 1200A, 1200B to thereby cut each of the first and second sheets 500, 502 of the first layer section 208 (see FIG. 10). Optionally, the anvil 1315 of the opposed upper or lower head portion 1200A, 1200B provides a rigid cutting surface that ensures a consistent cut line (e.g., crisp edges).

In another example the rotating cutting element 1314 has a discontinuous or stepped blade. In such an example, the rotating cutting element 1314 is rotated at a speed configured to provide a perforated cut to the first layer section 208. In such an example the perforated along the scribing line 402 allows for the retention of the upper and lower plurality of article sections 408A, 408B (see FIG. 10) relative to one another. The perforated cut between the first and second seams 404, 406 allows for easier handling of the upper and lower pluralities of article sections 408A, 408B. Stated another way, the upper and lower pluralities of article sections are then handled as a continuous roll having a consistent width from edge to edge.

As further shown in FIG. 13B the rotating cutting element 1314 includes a cutting shaft 1316 extending from the rotating cutting element 1314. The cutting shaft 1316 is configured to provide rotation to the rotating cutting element 1314. In a similar manner, each of the drive rollers 1304 for the endless tracks 1312 as well as the endless heating tracks 1302 includes a roller shaft 1318. The roller shafts 1318 provide rotation to each of the drive rollers 1304 to accordingly rotate the drive rollers 1304 and thereby move the endless tracks 1302, 1312.

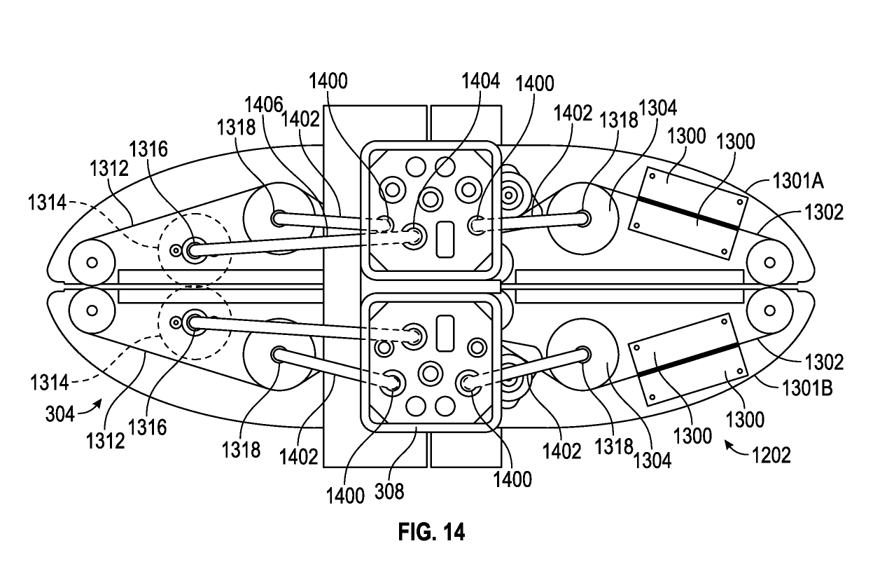

Referring now to FIG. 14, a side view of the inboard side 1202 of the cutting and joining head 304 is provided. As previously described herein, each of the cutting and joining sections 112, 114 includes one or more rotating elements. For instance with the joining section 114 one or more drive rollers 1304 are provided for the endless heating tracks 1302. In a similar manner, the cutting section 112 includes drive rollers 1304 for the endless tracks 1312 and optionally includes rotating cutting elements 1314 as previously described herein. Each of these rotatable elements including, but not limited to, the drive rollers 1304 and the rotating cutting elements 1314 include corresponding shafts. For instance, the rotating cutting elements 1314 each include a cutting shaft 1316. In a similar manner, the drive rollers 1304 for the endless heating tracks 1302 and the endless tracks 1312 each include corresponding roller shafts 1318. Each of the roller shafts 1318 and the cutting shafts 1316 are rotated to correspondingly rotate each of the drive rollers 1304 and the rotating cutting elements 1314, respectively.

In one example rotation is transmitted along the assembly arm 308 for instance with one or more shafts. In the case of the drive rollers 1304 a plurality of roller drive shafts 1400 are provided in each of the upper and lower portions of the arm assembly 308. In the example shown in FIG. 14 four roller drive shafts 1400 are provided for the drive rollers 1304. The roller drive shafts 1400 extend from corresponding motors at the base of the assembly arm 308 and transmit rotation to distal ends near the articulating joint 306. At the articulating joint 306 or immediately prior to it each of the roller drive shafts 1400 reaches its terminus. At the terminus the roller drive shafts 1400 coupled with roller intermediate shafts 1402 with a plurality of universal joints. The roller intermediate shaft 1402 extends laterally from the roller drive shaft 1400 to the corresponding roller shaft 1318 for the respective drive roller 1304. The roller drive shaft 1318 is coupled with the roller intermediate shaft 1402 with a plurality of universal joints to accordingly allow for the transmission of rotation from the roller intermediate shaft 1402 to the roller shaft 1318. Rotation is accordingly transmitted from the roller drive shafts 1400 to the roller shafts 1318 through the roller intermediate shafts 1402 to rotate the drive rollers 1304. The flexible drive coupling of the drive rollers 1304 with the roller drive shafts 1400 ensures the drive rollers are rotated at a consistent specified speed even with articulation of the articulating joint 306 to rotate the cutting and joining head 304 relative to the assembly arm 308.

In a similar manner each of the rotating cutting elements 1314 includes a corresponding cutting shaft 1316 that is rotated by a respective cutting drive shaft 1404. In the example shown in FIG. 14 the cutting drive shaft 1404 extends through the assembly arm 308 from one or more motors configured to rotate each of the cutting drive shafts 1404. Rotation of the cutting drive shaft 1404 at its terminus (immediately prior to the articulating joint 306) is transmitted to a cutting intermediate shaft 1406 through one or more universal joints. The cutting intermediate shaft 1406 extends laterally, as shown in FIG. 14, to the cutting shaft 1316 of each of the respective rotating cutting elements 1314. The cutting shaft 1316 is coupled with the cutting intermediate shaft 1406 with additional universal joints to facilitate a flexible coupling that transmits rotation. In a similar manner to each of the drive rollers 1304, the rotating cutting elements 1314 are thereby able to rotate at a specified speed for instance to cut each of the first and second sheets 500, 502 of the first layer section 208 during rotation of the cutting and joining head 304, for instance through operation of the articulating joint 306 to follow a scribing line (e.g., line 402).

The cutting and joining head 304 (including the joining section 114) and the edge joining head 608 (of the edge joiner 120) are constructed to facilitate the use of a variety of joining and cutting mechanisms. One example of the joining section 114 (and the edge joiner 120) is described herein including the plurality of heating elements 1300. Other examples of the joining section 114 (and edge joiner 120) include, but are not limited to, cartridge heaters, radiant heaters, and resistive of the material of the layered sheets (e.g., first layer section 208) directly or heating of the endless heating track 1302. Still other examples of the joining section 114 (and edge joiner 120) include, but are not limited to, heated air sources having heating elements and a localized air or gas nozzle configured to direct a heated fluid over one or more of the endless heating track 1302 or sheets of a layered sheet (e.g., sheets 500, 502 of the first layer section 208) to form the seams 404, 406, 600. Optionally, the joining section 114 (and edge joiner 120) uses the heated air source as a preheating unit directed at the portions of the layered sheet designated for sealing (e.g., downstream from the preheating location). The preheating facilitates the ready joining along the desired pattern (e.g., the scribing line 402) with another portion of the joining section 114, such as the heating elements 1300 and endless heating tracks 1302. In still other examples, the joining section 114 (and the edge joiner 120) includes, but is not limited to, ultrasonic or laser welding elements. Optionally, the joining section 114 (and the edge joiner 120) includes, but is not limited to, an adhesive applicator or adhesive tape applicator. The term heating element, heater or joining section as provided herein includes each of these joining mechanisms.

The cutting section 112 includes one or more mechanisms configured to cut a layered sheet (e.g., the layered section 208). One example is described herein including a rotating cutting element. Another example includes a static cutting element. Optionally, with a static or rotating cutting element, the blade of the element is actuated (e.g., deployed or retracted) with an actuator such as a solenoid. In another example, the cutting section 112 includes, but is not limited to, one or more ultrasonic cutting elements. In yet another example, the cutting section 112 includes, but is not limited to, one or more laser cutting elements.

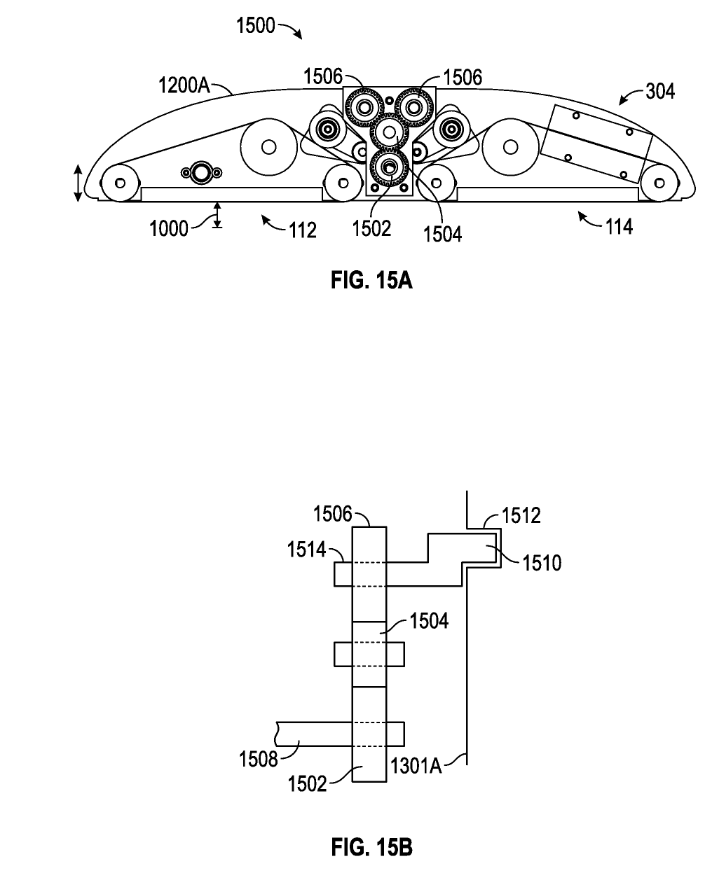

FIGS. 15A and 15B show one example of an elevation mechanism 1500 configured to raise and lower one or both of the upper and lower head portions 1200A, B of the cutting and joining head 304. Referring first to FIG. 15A, the upper head portion 1200A including the cutting and joining sections 112, 114 is shown. The elevation mechanism 1500 is centrally located relative to the cutting and joining sections 112, 114. For instance the elevation mechanism 1500 is provided in a relatively aligned configuration to the assembly arm 308 and the articulating joint 306. As described herein, the elevation mechanism 1500 provides an elevating feature to move the upper head portion 1200A relative to the lower head portion 1200B (e.g., expanding or contracting the article gap 1000). In one example, one or both of the upper and lower head portions 1200A, B includes an elevation mechanism 1500. In still another example each of the upper and lower head portions 1200A, 1200B include an elevation mechanism 1500. The elevation mechanism 1500 described herein facilitates the movement of the upper and lower head portions 1200A, 1200B in a caliper like fashion relative to the article gap 1000. Accordingly, the upper and lower head portions and their components including for instance the endless heating tracks 1302, the endless tracks 1312 and the rotating cutting elements 1314 are accordingly moved in an upward and downward fashion as desired to accordingly change the article gap 1000.

In one example the article gap 1000 is changed to account for differing materials having differing thicknesses fed through the cutting and joining head 304 (e.g., from either or both of the first and second sheet housings 204, 206 as shown in FIG. 10). In another example, elevation changes of the upper or lower head portions 1200A, 1200B are desired to increase the article gap 1000 and accordingly disengage both of the head portions 1200A, 1200B from a nipping engagement (or near nipping engagement) with the first layer section 208. Accordingly, as service is needed the cutting and joining head 304 is opened (e.g., the one or more elevation mechanisms expand the article gap 1000) and the cutting and joining head is readily retracted from the first layer section 208 to allow for removal of the cutting and joining head 304 for maintenance (e.g., replacement of the cutting element, the replacement of one or more of the endless tracks, the replacement or servicing of the heating elements 1300 or the like).

As further shown in FIG. 15A, the elevation mechanism 1500 in one example includes a plurality of gears configured to transmit movement to a plurality of locations of one or more of the upper or lower head portions 1200AB. For instance, as shown the elevation mechanism 1500 includes a drive gear 1502 and a plurality of driven gears 1506 (in the example shown two driven gears 1506 are provided). As further shown in FIG. 15A an intermediate gear 1504 is provided between the driven gears 1506 and the drive gear 1502. Accordingly rotation of the drive gear 1502 is correspondingly transmitted to the driven gears 1506 with the mechanism 1500.

Referring now to FIG. 15B, each of the driven gears 1506, the drive gear 1502, and the intermediate gear 1504 are shown in a schematic side view. As shown, the drive gear 1502 includes an elevator drive shaft 1508. In one example the elevator drive shaft 1502 extends through the assembly arm 308, through the articulating joint 306, and extends into the cutting and joining head 304 for instance with one or more universal joints. As further shown in FIG. 15B rotation transmitted along the elevator drive shaft 1508 is correspondingly transmitted through the intermediate gear 1504 to each of the driven gears 1506.

As further shown in FIG. 15B at least the driven gears 1506 include corresponding eccentric lugs 1510. The eccentric lugs 1510 of the driven gears 1506 are provided on corresponding driven shafts 1514. The eccentric lugs 1510 are received within corresponding lug recesses 1512, for instance of the upper head housing 1301A. As shown in FIG. 15B, with rotation of the shafts 1514 (transmitted through the drive gear 1502, intermediate gear 1504 and driven gear 1506) the eccentric lugs 1510 rotate within the lug recesses 1512. As the eccentric lugs 1510 rotate around the corresponding shafts 1514 the eccentric lugs 1510 raise or lower and correspondingly raise or lower the upper head housing 1301A (including the lug recesses 1512).

Stated another way, with rotation of each of the eccentric lugs 1510 the lug recesses 1512 as well as the upper head housing 1301A including the recesses are correspondingly moved upward and downward based on the rotation. That is to say, with rotation of the driven shafts 1514 by way of the interrelated gears 1502, 1504, 1506 the eccentric lugs 1510 of each of the shafts are correspondingly moved together. Each of the eccentric lugs 1510 moves at the same time, at the same rate and moves to the same position according to rotation transmitted through the chain of gears 1502, 1504, 1506. Accordingly, multipoint translation is provided to the upper head housing 1301A to ensure the upper head housing 1301A of the upper head portion 1200A raises and lowers in a consistent fashion without tipping of the upper head portion 1200A at either of its ends. In a similar manner, the lower head portion 1200B includes its own elevation mechanism 1500 in an example that facilitates movement of the lower head portion 1200B in a manner similar to the upper head portion 1200A.

FIGS. 16A-C show examples of articles that may be generated with the article assembly line 100 including the article manufacturing system 200 described herein. For instance, each of the article manufacturing stations 202A-N shown for instance in FIG. 2 are configured (e.g., by changes in the material of the sheets, changes in the scribing line, or changes in the cutting and joining operation) to provide differing article sections depending on the construction of a specified article.

One example of such an article is shown in FIG. 16A. The balloon 1600 shown in FIG. 16A extends from an upper apex 1602 to a lower apex 1604. In one example, the balloon 1600 includes a ballonet 1608 therein. The ballonet 1608 is selectively inflated and deflated to accordingly change the buoyancy of overall balloon 1600 to facilitate, for instance, the ascending or descending of the balloon 1600 to desired altitudes.

As shown in FIG. 16A, the balloon 1600 is formed with a plurality of article sections 1606. In one example, the plurality of article sections 1606 correspond to the upper or lower pluralities of article sections 408A, 408B previously described and shown for instance in FIG. 4. The article sections 1606 are assembled with the article manufacturing stations 202A-N in a stacked configuration corresponding to the article section stack 501 shown in FIG. 5B. A combination of the cutting and joining assemblies 110 and the edge joining assemblies 116 are used to form the seams of the balloon 1600. For instance, the cutting and joining assemblies form the seams 404, and the edge joining assemblies 116 provide the edge seams 600 that join each of the article sections 1606 with adjacent article sections. Optionally, article panels (also described herein) are assembled in a stacked configuration and seams 712 are formed at the interfaces between article panels to form the balloon 1600.

In one example the balloon 1600 is formed as the article section stack 501 previously described herein. For instance, referring to FIG. 9A the article section stack 501 is shown with a closed cavity 908. The cavity 908 corresponds to the interior volume of the balloon 1600. Similarly, the plurality of article sections 1606 correspond (in greater number) to the exemplary pluralities of article sections 400-522 shown in FIG. 5A. The article sections 1606 are formed in a stacked configuration (article section stack 501) with each of the article sections 1606 stacked one on top of the other and joined at their edges, for instance along the edge seams 600. Accordingly, the balloon 1600 with the seams 404, 600 formed is stacked as a result of the assembly method (the stations 202A-N, edge joining assemblies 116, and the like), and easily packaged (e.g., with the boxer 126 shown in FIG. 1). In another example, the boxer 126 includes but is not limited to a reel or spool configured to wrap the stacked and joined article sections 1606 of the finished balloon 1600 therearound.

In still another example, the balloon 1600 includes a ballonet 1608. Optionally, the ballonet 1608 is formed in a similar manner to the balloon 1600. For instance, the ballonet 1608 includes its own constituent article sections that are joined at seams 404 and then joined with adjacent article sections at edge seams such as the edge seams 600. The ballonet 1608 is assembled in a similarly stacked configuration to the balloon. After assembly of the ballonet 1608 the ballonet 1608 is optionally coupled with the balloon 1600 at the lower apex 1604. In one example, the ballonet is coupled with an automated joining system (e.g., a heat based joining system, laser joining system, stitching, adhesives, adhesive tapes, combinations of the same or the like). Optionally, the ballonet 1608 is joined with the balloon 1600 with one or more hand tools configured to join the ballonet 1608 and the balloon 1600 at the lower apex 1604.

Accordingly, the article assembly line 100 and the component article manufacturing system 200 (with the plurality of article manufacturing stations 202A-N and edge joining assemblies 116) are configured to automatically generate the entirety of the balloon 1600 (absent electronic components, ports and the like). Stated another way, each of the article sections 1606 of the balloon 1600 or a ballonet 1608 are rapidly formed with the article manufacturing system 200 and are assembled in a stacked and joined configuration to allow for easy storage, packaging and transport of the balloon 1600 as well as the ballonet 1608.

In another example shown in FIG. 16B a structural article 1610 having a plurality of inflatable cavities 1614 is provided. In the example the article 1610 is formed with a plurality of article sections 1612 The article section 1612 are in one example formed for instance with dual sheets such as the first and second sheets 500, 502 forming a first layer section 208 and delivered through at least one of the article manufacturing stations 202A-N shown in FIG. 2. The cutting and joining assembly 110, for instance the cutting and joining head 304, is transcribed over the first and second sheets 500, 502 in a linear pattern (e.g., with a linear square wave scribing line). In another example, cutting with the cutting and joining head 304 is suspended. Instead, the joining sections 114 of the cutting and joining head 304 provide the seams 1618. In another example, the edge seams 1616 shown between the article sections 1612 are formed by the edge joining assemblies 116 as shown in FIG. 2.

Accordingly, the structural article 1610 is formed with layered sheets (layer sections) that are acted upon to form the seams 1618 and then stacked with subsequent layered sheets to form additional article sections 1612. Optionally, each of the inflatable cavities 1614 are formed between the first and second sheets 500, 502 for instance with separate inflation ports providing separate inflation of each of the inflatable cavities 1614. In another example, the joining sections 114 of the cutting and joining assembly 110 are operated in a discontinuous fashion to accordingly provide ports between each of the inflatable cavities 1614. The inflation of a single inflatable cavity 1614 of one of the article section 1612 allows for transmission of a fluid for instance air, helium or the like across each of the inflated cavities 1614 of one or more of the article sections 1612.

In yet another example a series of bioreactor pods 1620 are shown in FIG. 16C as another example of an article assembled with the article assembly line 100 and the article manufacturing system 200. As shown in FIG. 16C, each of the bioreactor pods 1620 include a plurality of communicating pod pockets 1634. In one example, the bioreactor pods 1620 are coupled with a pump 1622 by way of an inflow manifold 1624. The pump 1622 moves fluid (e.g., bioreactive media) through each of the pod pockets 1634 and out through an outflow manifold 1626. For instance, in one example the fluid is moved by the pump 1622 into the inflow manifold 1624 and thereafter allowed to move either under pressure or passively through the pod pockets 1634 for instance by way of a number of seam passages 1632 provided at each of the seams 1630.

In one example, the bioreactor pods 1620 are formed with the article manufacturing system 200 previously described herein. For instance, one or more of the article manufacturing stations 202A receive first and second sheets such as the first and second sheets 500, 502 in a layered configuration. The cutting and joining assembly 110 scribes in a transverse fashion (e.g., as a square wave) across the first and second sheets 500, 502 on the first layer section 208 to provide the seams 1630. Optionally, the seams 1630 are provided discontinuously to form each of the seam passages 1632 through the seams 1630. In one example, the joining section 114 of the cutting and joining heads 304 discontinues the joining operation (e.g., discontinues heating temporarily) to interrupt the seam 1630 and there by form the seam passage 1632. Stated another way joining is continued along the seams 1630 until a specified location for a seam passage 1632 is reached. At the location or a point or immediately prior to the location the joining section 114 heating elements are turned off and the cooling platens cool the portions of the cutting and joining head 304 engaged with the first layered section 208. Accordingly, the seam passages 1632 are formed by discontinuity in the joining of the first and second sheets 500, 502 along the seams 1630.

In one example, a single article manufacturing station 202 is used to generate each of the bioreactor pods 1620. In another example, a plurality of article manufacturing stations 202A-N are provided to form each of the bioreactor pods 1620 in an inter-connected fashion, for instance where each of the bioreactor pods 1620 are coupled along their length for instance with one or more edge seams formed by the edge joining assemblies 116 that allow for a hanging sheet of a plurality of pod pockets 1634 provided in horizontal rows and vertical columns of the pod pockets 1634. Optionally the edge joining assemblies 116 shown in FIG. 2 are not operated to accordingly keep the bioreactor pods 1620 separate from each other. The pods 1620 are stacked through layering provided by the article manufacturing stations 202A-N to facilitate packing of a plurality of stacked bioreactor pods 1620.

As shown herein, the article manufacturing system 200 and the article assembly line 100 are able to generate a variety of articles including, but not limited to, balloons and other sheet based articles. Some examples of articles assembled and manufactured with the article manufacturing system 200 and the article assembly line 100 are shown in FIGS. 16A-C and also include, but are not limited to, balloons, aerostats, airships, inflatable housing structures, mats, container or vessel liners, bioreactor devices, inflatable bridge structures, skeletal or structural support elements, inflatable lifting structures or the like. Accordingly, the article assembly line 100, the article manufacturing system 200 and the constituent component of the article manufacturing system 200 (e.g., the article manufacturing stations 202A-N and the edge joining assemblies 116) are configured to generate one or more articles with reconfiguring of the article manufacturing stations 202A-N the edge joining assemblies 116 and the like. Accordingly, while some focus has been provided in the description for the automated assembly and manufacture of a balloon (e.g., the balloon 1600) the article assembly line 100 and the article manufacturing system 200 are not limited to the automated assembly and manufacture of a balloon but instead include other sheet based articles as described herein and their equivalents.

### Various Notes & Examples

Example 1 can include subject matter such as can include a method of automated manufacturing of balloons and sheet based articles comprising: layering a second sheet over a first sheet, the layered first and second sheets form a first layer section; translating the first layer section relative to a cutting and joining assembly; and cutting and joining the first layer section into article sections with the cutting and joining assembly, cutting and joining including: scribing the cutting and joining assembly along a scribing line across the first layer section as the first layer section is translating, joining the first and second sheets along the scribing line with the cutting and joining assembly, the first and second sheets a first plurality of article sections, and cutting the first layer section along the scribing line according to the scribing and translating to separate the first plurality of article sections, each of the first and second sheets cut into first article portions facing each other.

Example 2 can include, or can optionally be combined with the subject matter of Example 1, to optionally include wherein layering the first sheet over the second sheet includes layering a first continuous sheet of material over a second continuous sheet of material.

Example 3 can include, or can optionally be combined with the subject matter of one or any combination of Examples 1 or 2 to optionally include wherein cutting and joining the first layer section into the article sections includes continuously cutting and joining the first and second continuous sheets of material into a continuous and staggered first plurality of article sections.

Example 4 can include, or can optionally be combined with the subject matter of one or any combination of Examples 1 through 3 to optionally include wherein cutting and joining the first layer section into the first plurality of article sections includes cutting and joining the first layer section into first and second staggered articles sections for respective separate first and second articles at the same time.

Example 5 can include, or can optionally be combined with the subject matter of one or any combination of Examples 1-4 to optionally include layering a third sheet over a fourth sheet, the layered third and fourth sheets form a second layer section; and repeating translating and cutting and joining for the second layer section to form a second plurality of article sections of the second layer section.

Example 6 can include, or can optionally be combined with the subject matter of Examples 1-5 to optionally include stacking the second plurality of article sections of the second layer section with the first plurality of article sections of the first layer section to form at least one article assembly, and at least two edges of each of the first and second plurality of article sections are aligned edges; translating the article assembly relative to at least one edge joining assembly; and joining the aligned edges with the at least one edge joining assembly according to the translating of the article assembly.

Example 7 can include, or can optionally be combined with the subject matter of Examples 1-6 to optionally include coupling a tendon along the aligned edges of the first and second plurality of article sections.

Example 8 can include, or can optionally be combined with the subject matter of Examples 1-7 to optionally include wherein the at least one article assembly includes at least an article section of each of the first and second plurality of article sections, at least one of the article sections is a first end article section, and at least one of the article sections is a second end article section, the method comprising: joining the first and second end article sections along closing edges of the first and second end article sections.

Example 9 can include, or can optionally be combined with the subject matter of Examples 1-8 to optionally include wherein joining the first and second end article sections along closing edges includes: manipulating the closing edges of the first and second end article sections into alignment, and joining the closing edges while the closing edges are manipulated into alignment.

Example 10 can include, or can optionally be combined with the subject matter of Examples 1-9 to optionally include an article manufacturing system comprising: at least one article manufacturing station configured to form article sections, the at least one article manufacturing system includes: a first sheet housing configured to dispense a first sheet; a second sheet housing configured to dispense a second sheet over the first sheet, the first and second sheets forming a first layer section; a translation mechanism configured to translate the first layer section; and a cutting and joining assembly including: a cutting and joining head configured to join the first and second sheets of the first layer section into article sections along a scribing line and cut the article sections along the scribing line, and an assembly arm coupled with the cutting and joining head, the assembly arm configured to move the cutting and joining head relative to the translating first layer section along the scribing line.

Example 11 can include, or can optionally be combined with the subject matter of Examples 1-10 to optionally include wherein the at least one article manufacturing station includes first and second article manufacturing stations in series, the first article manufacturing station configured to join the first and second sheets into a first plurality of article sections and cut the article sections, and the second article manufacturing station configured to join third and fourth sheets of a second layer section into a second plurality of article sections along a second scribing line and cut the second plurality of article sections along the second scribing line, the first and second plurality of article sections are stacked in an aligned configuration.

Example 12 can include, or can optionally be combined with the subject matter of Examples 1-11 to optionally include at least one edge joining assembly positioned along at least two aligned edges of the stacked first and second plurality of article sections, the at least one edge joining assembly configured to join the first and second plurality of article sections along the at least two aligned edges.

Example 13 can include, or can optionally be combined with the subject matter of Examples 1-12 to optionally include wherein the at least one edge joining assembly includes: at least one spacing roller for at least one of the first or second plurality article sections, the at least one spacing roller configured to space the first plurality of article sections from the second plurality of article sections, at least one joining roller downstream from the at least one spacing roller, the at least one joining roller configured to guide the portions of the second sheet of the first plurality of article sections toward the portions of the third sheet of the second plurality of article sections at a location upstream from an edge joining head, and the edge joining head configured to join at least the portions of the second sheet of the first plurality of article sections with the third sheet of the second plurality of article sections along the at least two aligned edges.

Example 14 can include, or can optionally be combined with the subject matter of Examples 1-13 to optionally include at least one tendon liner positioned along the at least two aligned edges, the at least one tendon liner includes: a tendon spool, and a tendon applicator wedge configured for interposing between the at least two aligned edges.

Example 15 can include, or can optionally be combined with the subject matter of Examples 1-14 to optionally include wherein the cutting and joining head includes: a joining section, and a cutting section downstream from the joining section.

Example 16 can include, or can optionally be combined with the subject matter of Examples 1-15 to optionally include wherein the joining section includes at least one joining assembly including: at least one heating element, first and second endless heating tracks, the first and second endless heating tracks configured to move in correspondence with the first layer section along the first and second sheets, respectively, and the at least one heating element heats at least one of the first or second endless heating tracks, and wherein at least one of the heated first or second endless heating tracks is configured to join the portions of the first and second sheets into article sections.

Example 17 can include, or can optionally be combined with the subject matter of Examples 1-16 to optionally include wherein the cutting section includes at least one rotating cutting element configured to cut at least one of the first or second sheets of the first layer section.

Example 18 can include, or can optionally be combined with the subject matter of Examples 1-17 to optionally include wherein the joining section includes first and second joining assemblies configured to form first and second seams of the article sections, respectively, along the scribing line between the first and second sheets, and the cutting section is configured to cut the article sections between the first and second seams to separate the article sections.

Example 19 can include, or can optionally be combined with the subject matter of Examples 1-18 to optionally include wherein an articulating joint is between the cutting and joining head and the assembly arm, and the articulating joint is configured to articulate the cutting and joining head relative to the assembly arm along the scribing line.

Example 20 can include, or can optionally be combined with the subject matter of Examples 1-19 to optionally include wherein the assembly arm is configured to move the cutting and joining head along the scribing line.

Example 21 can include, or can optionally be combined with the subject matter of Examples 1-20 to optionally include an article cutting and joining assembly comprising: a cutting and joining head configured to cut and join a layered sheet, the cutting and joining head includes: an upper head portion, a lower head portion spaced from the upper head portion by an article gap, and wherein at least one of the upper or lower head portions includes a joining section, and at least one of the upper or lower head portions includes a cutting section downstream from the joining section in a translation direction of the layered sheet; an assembly arm coupled with the cutting and joining head; and an articulating joint coupled interposed between the cutting and joining head.

Example 22 can include, or can optionally be combined with the subject matter of Examples 1-21 to optionally include wherein each of the upper and lower head portions includes the joining section, and each of the upper and lower head portions includes the cutting section.

Example 23 can include, or can optionally be combined with the subject matter of Examples 1-22 to optionally include wherein the joining section includes upper and lower joining assemblies coupled with the upper and lower head portions, respectively.

Example 24 can include, or can optionally be combined with the subject matter of Examples 1-23 to optionally include wherein each of the upper and lower joining assemblies includes: a heating element, an endless heating track configured to move in correspondence with a layered sheet, and the heating element is configured to heat the endless heating track, and wherein the heated endless heating track is configured to join layers of the layered sheet.

Example 25 can include, or can optionally be combined with the subject matter of Examples 1-24 to optionally include wherein the joining section includes one or more heating elements configured to heat a layered sheet, and wherein the cutting and joining head includes a temperature sensor downstream from the joining section, the temperature sensor configured to measure the temperature of the layered sheet.

Example 26 can include, or can optionally be combined with the subject matter of Examples 1-25 to optionally include wherein the cutting and joining head includes a cooling platen downstream from the joining section, the cooling platen configured to cool the layered sheet.

Example 27 can include, or can optionally be combined with the subject matter of Examples 1-26 to optionally include wherein the assembly arm includes an upper arm portion and a lower arm portion spaced from the upper arm portion by the article gap, the articulating joint includes an upper joint portion and a lower joint portion spaced from the upper joint portion by the article gap, and wherein the cutting and joining head, the articulating joint and the assembly arm are configured to receive a layered sheet within the article gap.

Example 28 can include, or can optionally be combined with the subject matter of Examples 1-27 to optionally include wherein each of the upper and lower portions of the cutting and joining head, the articulating joint and the assembly arm move together to maintain the alignment of the upper head portion with the lower head portion of the cutting and joining head.

Example 29 can include, or can optionally be combined with the subject matter of Examples 1-28 to optionally include wherein the cutting section includes at least one rotating cutting element configured to cut a layered sheet.

Example 30 can include, or can optionally be combined with the subject matter of Examples 1-29 to optionally include wherein the cutting section includes: a first rotating cutting element coupled with the upper head portion, and an anvil coupled with the lower head portion.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of automated manufacturing of balloons and sheet based articles comprising:
layering a second sheet over a first sheet, the layered first and second sheets form a first layer section;
translating the first layer section relative to a cutting and joining assembly; and
cutting and joining the first layer section into article sections with the cutting and joining assembly, cutting and joining including:
scribing the cutting and joining assembly along a scribing line across the first layer section as the first layer section is translating,
joining the first and second sheets along the scribing line with the cutting and joining assembly, the first and second sheets a first plurality of article sections, and
cutting the first layer section along the scribing line according to the scribing and translating to separate the first plurality of article sections, each of the first and second sheets cut into first article portions facing each other.

2. The method of claim 1, wherein layering the first sheet over the second sheet includes layering a first continuous sheet of material over a second continuous sheet of material.

3. The method of claim 2, wherein cutting and joining the first layer section into the article sections includes continuously cutting and joining the first and second continuous sheets of material into a continuous and staggered first plurality of article sections.

4. The method of claim 1, wherein cutting and joining the first layer section into the first plurality of article sections includes cutting and joining the first layer section into first and second staggered articles sections for respective separate first and second articles at the same time.

5. The method of claim 1 comprising:
layering a third sheet over a fourth sheet, the layered third and fourth sheets form a second layer section; and
repeating translating and cutting and joining for the second layer section to form a second plurality of article sections of the second layer section.

6. The method of claim 5, comprising:
stacking the second plurality of article sections of the second layer section with the first plurality of article sections of the first layer section to form at least one article assembly, and at least two edges of each of the first and second plurality of article sections are aligned edges;
translating the article assembly relative to at least one edge joining assembly; and
joining the aligned edges with the at least one edge joining assembly according to the translating of the article assembly.

7. The method of claim 6 comprising coupling a tendon along the aligned edges of the first and second plurality of article sections.

8. The method of claim 6, wherein the at least one article assembly includes at least an article section of each of the first and second plurality of article sections, at least one of the article sections is a first end article section, and at least one of the article sections is a second end article section, the method comprising:
joining the first and second end article sections along closing edges of the first and second end article sections.

9. The method of claim 8, wherein joining the first and second end article sections along closing edges includes:
manipulating the closing edges of the first and second end article sections into alignment, and
joining the closing edges while the closing edges are manipulated into alignment.

10. An article manufacturing system comprising:
at least one article manufacturing station configured to form article sections, the at least one article manufacturing system includes:
a first sheet housing configured to dispense a first sheet;
a second sheet housing configured to dispense a second sheet over the first sheet, the first and second sheets forming a first layer section;
a translation mechanism configured to translate the first layer section; and
a cutting and joining assembly including:
a cutting and joining head configured to join the first and second sheets of the first layer section into article sections along a scribing line and cut the article sections along the scribing line, and
an assembly arm coupled with the cutting and joining head, the assembly arm configured to move the cutting and joining head relative to the translating first layer section along the scribing line.

11. The article manufacturing system of claim 10, wherein the at least one article manufacturing station includes first and second article manufacturing stations in series,
the first article manufacturing station configured to join the first and second sheets into a first plurality of article sections and cut the article sections, and
the second article manufacturing station configured to join third and fourth sheets of a second layer section into a second plurality of article sections along a second scribing line and cut the second plurality of article sections along the second scribing line, the first and second plurality of article sections are stacked in an aligned configuration.

12. The article manufacturing system of claim 11 comprising at least one edge joining assembly positioned along at least two aligned edges of the stacked first and second plurality of article sections, the at least one edge joining assembly configured to join the first and second plurality of article sections along the at least two aligned edges.

13. The article manufacturing system of claim 12, wherein the at least one edge joining assembly includes:
at least one spacing roller for at least one of the first or second plurality article sections, the at least one spacing roller configured to space the first plurality of article sections from the second plurality of article sections,
at least one joining roller downstream from the at least one spacing roller, the at least one joining roller configured to guide the portions of the second sheet of the first plurality of article sections toward the portions of the third sheet of the second plurality of article sections at a location upstream from an edge joining head, and
the edge joining head configured to join at least the portions of the second sheet of the first plurality of article sections with the third sheet of the second plurality of article sections along the at least two aligned edges.

14. The article manufacturing system of claim 12 comprising at least one tendon liner positioned along the at least two aligned edges, the at least one tendon liner includes:
a tendon spool, and
a tendon applicator wedge configured for interposing between the at least two aligned edges.

15. The article manufacturing system of claim 10, wherein the cutting and joining head includes:
a joining section, and
a cutting section downstream from the joining section.

16. The article manufacturing system of claim 15, wherein the joining section includes at least one joining assembly including:
at least one heating element,
first and second endless heating tracks, the first and second endless heating tracks configured to move in correspondence with the first layer section along the first and second sheets, respectively, and the at least one heating element heats at least one of the first or second endless heating tracks, and
wherein at least one of the heated first or second endless heating tracks is configured to join the portions of the first and second sheets into article sections.

17. The article manufacturing system of claim 15, wherein the cutting section includes at least one rotating cutting element configured to cut at least one of the first or second sheets of the first layer section.

18. The article manufacturing system of claim 15, wherein the joining section includes first and second joining assemblies configured to form first and second seams of the article sections, respectively, along the scribing line between the first and second sheets, and
the cutting section is configured to cut the article sections between the first and second seams to separate the article sections.

19. The article manufacturing system of claim 10, wherein an articulating joint is between the cutting and joining head and the assembly arm, and the articulating joint is configured to articulate the cutting and joining head relative to the assembly arm along the scribing line.

20. The article manufacturing system of claim 10, wherein the assembly arm is configured to move the cutting and joining head along the scribing line.

21. An article cutting and joining assembly comprising:
a cutting and joining head configured to cut and join a layered sheet, the cutting and joining head includes:
an upper head portion,
a lower head portion spaced from the upper head portion by an article gap, and
wherein at least one of the upper or lower head portions includes a joining section, and at least one of the upper or lower head portions includes a cutting section downstream from the joining section in a translation direction of the layered sheet;
an assembly arm coupled with the cutting and joining head; and
an articulating joint coupled interposed between the cutting and joining head.

22. The article cutting and joining assembly of claim 21, wherein each of the upper and lower head portions includes the joining section, and each of the upper and lower head portions includes the cutting section.

23. The article cutting and joining assembly of claim 21, wherein the joining section includes upper and lower joining assemblies coupled with the upper and lower head portions, respectively.

24. The article cutting and joining assembly of claim 23, wherein each of the upper and lower joining assemblies includes:
a heating element,
an endless heating track configured to move in correspondence with a layered sheet, and the heating element is configured to heat the endless heating track, and
wherein the heated endless heating track is configured to join layers of the layered sheet.

25. The article cutting and joining assembly of claim 21, wherein the joining section includes one or more heating elements configured to heat a layered sheet, and
wherein the cutting and joining head includes a temperature sensor downstream from the joining section, the temperature sensor configured to measure the temperature of the layered sheet.

26. The article cutting and joining assembly of claim 25, wherein the cutting and joining head includes a cooling platen downstream from the joining section, the cooling platen configured to cool the layered sheet.

27. The article cutting and joining assembly of claim 21, wherein the assembly arm includes an upper arm portion and a lower arm portion spaced from the upper arm portion by the article gap,
the articulating joint includes an upper joint portion and a lower joint portion spaced from the upper joint portion by the article gap, and
wherein the cutting and joining head, the articulating joint and the assembly arm are configured to receive a layered sheet within the article gap.

28. The article cutting and joining assembly of claim 27, wherein each of the upper and lower portions of the cutting and joining head, the articulating joint and the assembly arm move together to maintain the alignment of the upper head portion with the lower head portion of the cutting and joining head.

29. The article cutting and joining assembly of claim 21, wherein the cutting section includes at least one rotating cutting element configured to cut a layered sheet.

30. The article cutting and joining assembly of claim 29, wherein the cutting section includes:
a first rotating cutting element coupled with the upper head portion, and
an anvil coupled with the lower head portion.
